(19) United States
(12) Patent Application Publication
(10) Pub. No.: US 2015/0117619 A1
(43) Pub. Date: Apr. 30, 2015

(54) HALL MONITOR SYSTEM

(71) Applicant: I3 Holdings Group LLC, Joplin, MO (US)

(72) Inventors: Brian M. Carpenter, Joplin, MO (US); John C. Johnson, Joplin, MO (US); RIchard A. Brust, Carthage, MO (US)

(73) Assignee: I3 Holdings Group LLC, Joplin, MO (US)

(21) Appl. No.: 14/063,769

(22) Filed: Oct. 25, 2013

(51) Int. Cl. H04M 3/51; G07C 9/00

(52) U.S. Cl. CPC H04M 3/5116; G07C 9/00182; G07C 2009/00261
USPC 379/39; 340/5.7

(57) ABSTRACT

A hall monitor system includes a telephone system, a video surveillance system, and an access control system that work together to provide a fully-integrated system that can respond to a number of different emergency events. Interfaces between these systems are defined, emergency events are defined, and each of these systems is programmed with customized functions that support the defined emergency events. The customized functions that support the defined emergency events can include initiating one or more of the emergency events from any of the telephone system, video surveillance system, and access control system, making mass notification of an emergency event by the telephone system, displaying at least one image from at least one camera corresponding to an initiated emergency event from the video surveillance system, and locking or unlocking some or all of the doors by the access control system depending on the emergency event.

### BACKGROUND

1. Technical Field

This disclosure generally relates to systems for providing services at public or private facilities, and more particularly relates to a hall monitor system that can take appropriate action when any of a number of emergency events occurs.

2. Background Art

School shootings have become more and more common, risking the health and safety of students and staff when a shooter comes into the school. Many schools have no security or minimal security, making it very easy for an intruder to gain access to the school and hence, the students and staff in the school. Many school districts have recognized the need for more security, and have added access control systems that control access to the school. For example, an access control system could lock all doors, including classroom doors, during class periods, and unlock the doors only between classes. In addition, an access control system can restrict access for many of the exterior doors to those who are authorized to enter, such as those who a keycard or a code that can be entered on a keypad. Other measures have been adopted by many schools to enhance the security and safety of the students and staff, including video surveillance systems and security systems. However, these systems are not integrated with each other, which results in the need to program and maintain each separate systems independently of the other systems.

### BRIEF SUMMARY

A hall monitor system includes a telephone system, a video surveillance system, and an access control system that work together to provide a fully-integrated system that can respond to a number of different emergency events. Interfaces between these systems are defined, emergency events are defined, and each of these systems is programmed with customized functions that support the defined emergency events. The customized functions that support the defined emergency events can include initiating one or more of the emergency events from any of the telephone system, video surveillance system, and access control system, making mass notification of an emergency event by the telephone system, displaying at least one image from at least one camera corresponding to an initiated emergency event from the video surveillance system, and locking or unlocking some or all of the doors by the access control system depending on the emergency event.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a hall monitor system;

FIG. 2 is a block diagram of the telephone system shown in FIG. 1;

FIG. 3 is a block diagram of the video surveillance system shown in FIG. 1;

FIG. 4 is a block diagram of the access control system shown in FIG. 1;

FIG. 5 is a block diagram of the security system shown in FIG. 1;

FIG. 6 is flow diagram of a method for defining interfaces between components in the hall monitor system;

FIG. 7 is a block diagram showing one specific implementation that could correspond to the method in FIG. 6;

FIG. 8 is a flow diagram of a method for defining emergency events and possible functions relating to the emergency events;

FIG. 9 is a block diagram showing examples of possible emergency events;

FIG. 10 is a block diagram showing examples of possible initiation of emergency events;

FIG. 11 is a block diagram showing examples of possible actions in response to emergency events;

FIG. 12 is a block diagram showing examples of possible monitoring during emergency events;

FIG. 13 is a block diagram showing examples of possible control for emergency events;

FIG. 14 is a flow diagram of a method for defining how emergency events are initiated by various components in the hall monitor system;

FIG. 15 is a flow diagram of a method for defining actions for emergency events by various components in the hall monitor system;

FIG. 16 is a flow diagram of a method for defining monitoring for emergency events by various components in the hall monitor system;

FIG. 17 is a flow diagram of a method for defining control for emergency events by various components in the hall monitor system;

FIG. 18 is a sample screen showing how to provide a 911 alert for the hall monitor system;

FIGS. 19-20 each shows sample programmable customized function of the telephone system to support the hall monitor system;

FIG. 21 shows a sample e-mail that could be sent by the hall monitor system; and

FIGS. 22-55 each shows a sample programmable customized function of the telephone system to support the hall monitor system.

### DETAILED DESCRIPTION

The issue of safety at schools and at work has taken on increased importance in the wake of the many deaths that result from shootings in schools and workplaces. Custom-designing a system for handling emergency events using proprietary hardware and software would be very expensive, typically outside the price range of most public school systems.

Many schools have increased security of their campuses by installing video surveillance systems that provide different views from different cameras. Some have also installed access control systems that control the access to and from buildings in the campus using electronically-controlled door locks. However, known systems do not provide a fully-integrated solution to hall monitoring.

A hall monitor system as disclosed and claimed herein includes a telephone system, a video surveillance system, and an access control system that work together to provide a fully-integrated system that can respond to a number of different emergency events. Interfaces between these systems are defined, emergency events are defined, and each of these systems is programmed with customized functions that support the defined emergency events. The customized functions that support the defined emergency events can include initiating one or more of the emergency events from any of the telephone system, video surveillance system, and access control system, making mass notification of an emergency event by the telephone system, displaying at least one image from at least one camera corresponding to an initiated emergency event from the video surveillance system, and locking or unlocking some or all of the doors by the access control system depending on the emergency event.

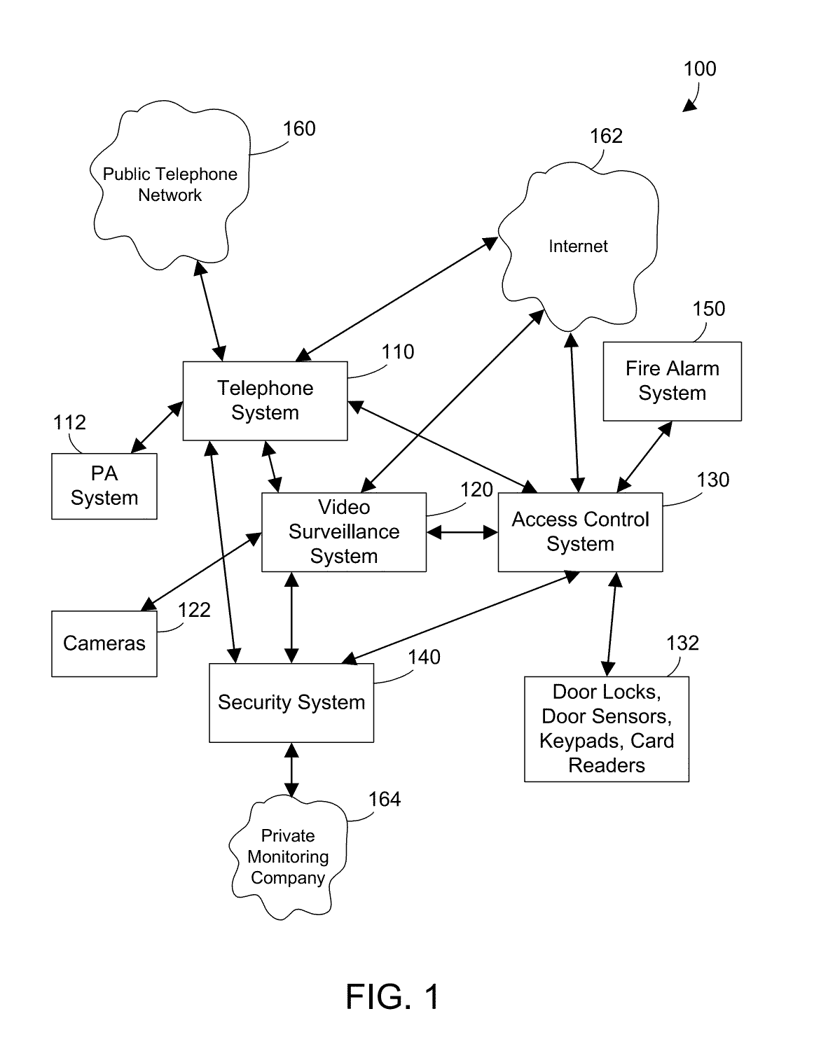

Referring to FIG. 1, one specific example of a hall monitor system 100 includes a telephone system 110, a video surveillance system 120, an access control system 130, a security system 140, and a fire alarm system 150. The telephone system 110, video surveillance system 120, access control system 130, and security system 140 are all interconnected to each other, and are subsystems of the hall monitor system. The telephone system 110 is also coupled to a public telephone network 160, to a public announcement (PA) system 112, and to the Internet 162. The video surveillance system 120 is coupled to one or more cameras 122 and to the Internet 162. Cameras 122 can include both video cameras as well as still-shot cameras. The access control system 130 is coupled to the fire alarm system 150 and to devices 132 such as door locks, door sensors, keypads, card readers, and any other devices that may be used to control access to a facility, including biometric identification devices such as fingerprint readers, face scanners, hand scanners, retina scanners, etc. The security system 140 is coupled to a private monitoring company 164. Thus, when the security system 140 generates an alarm, the alarm is reported to the private monitoring company 164, as is known in the art. Note the connection between the security system 140 and the private monitoring company 164 can be made in any suitable way, including telephone lines, wireless communication, satellite communication, and other network communication, including hardwire, wireless, and any suitable combination of technologies. In similar fashion, connection to the public telephone network 160 and to the Internet 162 can be made in any suitable way, including telephone lines, wireless communication, satellite communication, and other network communication, including hardwire, wireless, and any suitable combination of technologies.

While the hall monitor system 100 in FIG. 1 includes a security system 140 and a fire alarm system 150, these systems are not necessary to the functioning of the hall monitor system. However, because many facilities have existing security systems and fire alarm systems, these could be integrated into the hall monitor system as shown in FIG. 1 and discussed in more detail below.

The hall monitor system 100 in FIG. 1 thus discloses an apparatus comprising: a telephone system that provides a plurality of telephony functions and provides a first plurality of customized functions supported by the telephone system for a plurality of emergency events; a video surveillance system coupled to the telephone system that provides at least one camera interface coupled to at least one camera, that provides a plurality of video surveillance functions, and that provides a second plurality of customized functions supported by the video surveillance system for the plurality of emergency events; and an access control system coupled to the telephone system and coupled to the video surveillance system that provides at least one door lock interface to a plurality of door locks, that provides a plurality of access control functions, and that provides a third plurality of customized functions supported by the access control system for the plurality of emergency events.

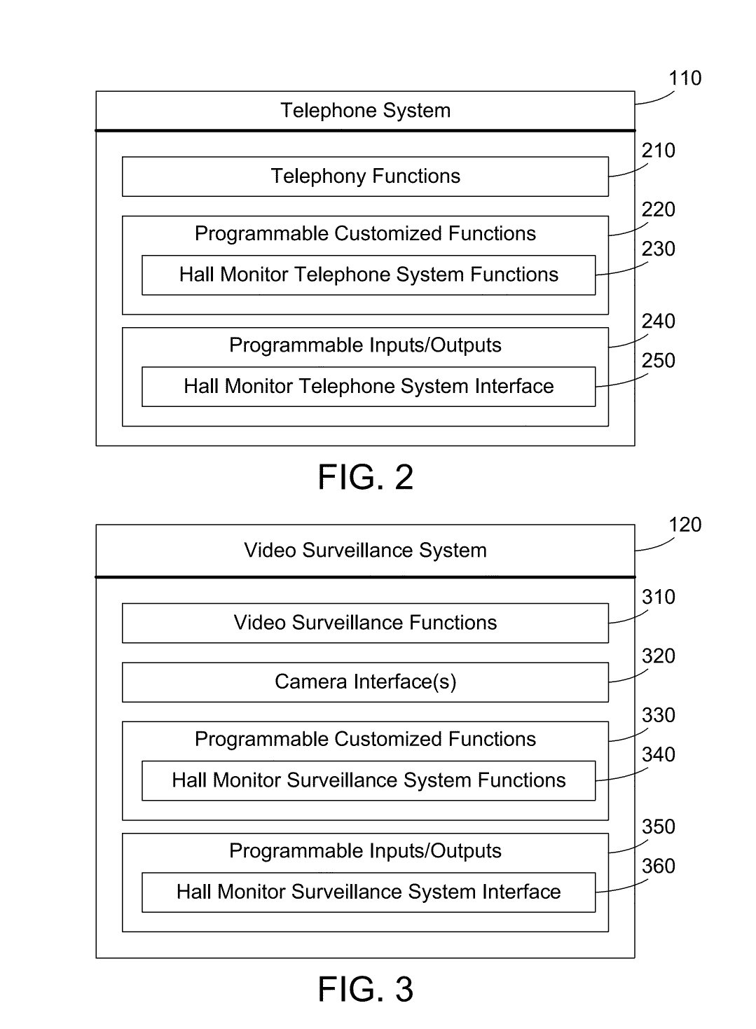

Referring to FIG. 2, one specific example of the telephone system 110 includes telephony functions 210, programmable customized functions 220, and programmable input/outputs 240. The telephony functions 210 represent the native functions provided by the telephone system 110, which can include any suitable telephony functions, whether currently known or developed in the future. In one specific implementation, the telephone system 110 is based on Asterisk open-source software running on a suitable hardware platform, such as a personal computer running Linux or a Linux-based server computer. An Asterisk telephone system provides a software implementation of a telephone private branch exchange (PBX), referred to in Asterisk terminology as FreePBX. Asterisk provides a powerful framework for many common telephony functions, including caller ID, call forwarding, call transferring, call conferencing, voicemail, interactive voice response (phone menus), voice over internet protocol (VOIP), etc. Asterisk has been deployed in over one million telephone systems in 170 countries. Detailed information about the Asterisk open-source software is available in Madsen et al., “Asterisk The Definitive Guide”, 3rd Edition, 2011.

Programming telephone system 110 with standard telephony functions 210 is well-known in the art for an Asterisk-based telephone system, as shown in the book referenced in the preceding paragraph. In addition, Asterisk open-source software also provides the capability of customizing Asterisk to perform different functions. The programmable customized functions 220 are customized functions defined in the telephone system 110 that provide hall monitor telephone system functions 230, and the programmable inputs/outputs 240 provides the hall monitor telephone system interface 250. The ability to customize the telephone system using programmable customized functions 220 and programmable inputs/output 240 provides a way to integrate the telephone system 110 to operate in a seamless manner with the video surveillance system 120 and the access control system 130 to provide an overall hall monitor system as described herein. Note the term “programmable inputs/outputs” as used herein can mean discrete signals or groups of signals on a hardware interface, as well as software interfaces such as application programming interfaces (APIs) that allow two systems to inter-communicate.

Referring to FIG. 3, one specific example of the video surveillance system 120 includes video surveillance functions 310 and camera interfaces 320 that connect to one or more cameras, such as cameras 122 shown in FIG. 1. One specific example of a suitable video surveillance system 120 is a CompleteView video surveillance system sold by Salient Systems. CompleteView is software that runs on a suitable hardware platforms, such as a personal computer running Windows XP, Windows Vista, or Windows Server 2003-2012. The surveillance functions 310 and camera interfaces 320 represent the native functions provided by the video surveillance system 120, whether currently known or developed in the future. Video surveillance functions 310 may can include any suitable video surveillance functions, and video surveillance system 120 may include any other type or number of interfaces, to surveillance equipment, whether currently known or developed in the future. The programmable customized functions 330 are customized functions defined in the video surveillance system 120 that provide hall monitor surveillance system functions 340, and the programmable inputs/outputs 350 provide the hall monitor surveillance system interface 360.

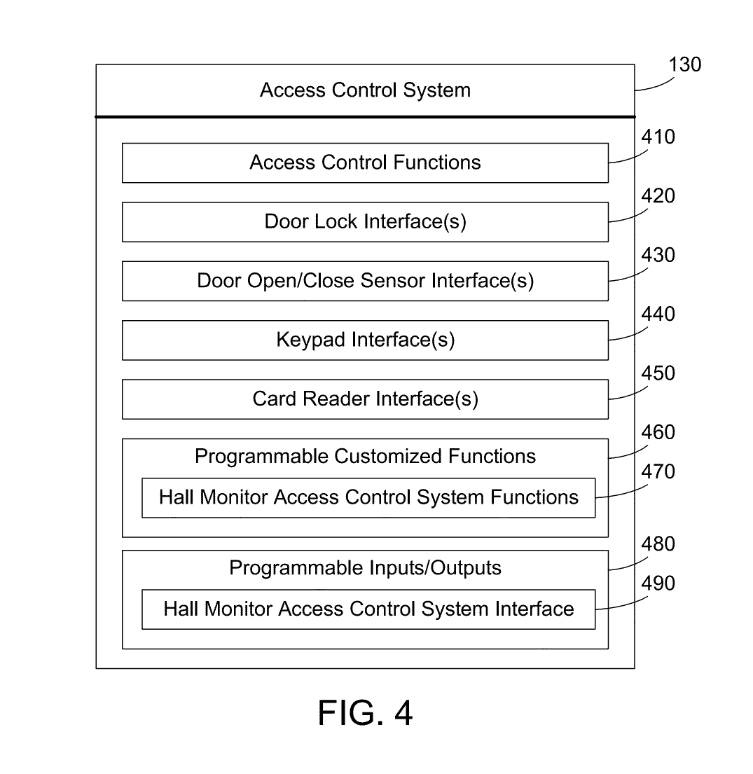

FIG. 4 shows one specific example of the access control system 130, which includes access control functions 410, one or more door lock interfaces 420, one or more door open/close sensor interfaces 430, one or more keypad interfaces 440, and one or more card reader interfaces 450. Note the interfaces 420, 430, 440 and 450 are software interfaces that are available for use, and do not imply these interfaces are always needed or used for each installation. Thus, one installation may have door lock interfaces 430 and door open/close sensor interfaces 440, but may not provide any keypads or card readers, so the keypad interface(s) 440 and card reader interface(s) would be unused. One specific implementation for access control system 130 is an access control system developed by DSX Access Systems, Inc., which typically includes a combination of Windows-based software that runs on a personal computer platform and custom hardware that interfaces to physical devices, such as door locks and sensors, keypads and card readers. The access control functions 410 and interfaces 420, 430, 440 and 450 represent the native functions provided by the access control system 130, which can include any suitable access control functions, whether currently known or developed in the future. Access control system 130 may also include any other type or number of interfaces, whether currently known or developed in the future. The programmable customized functions 460 are customized functions defined in the access control system 130 that provide hall monitor access control system functions 470, and the programmable inputs/outputs 480 provide the hall monitor access control system interface 490.

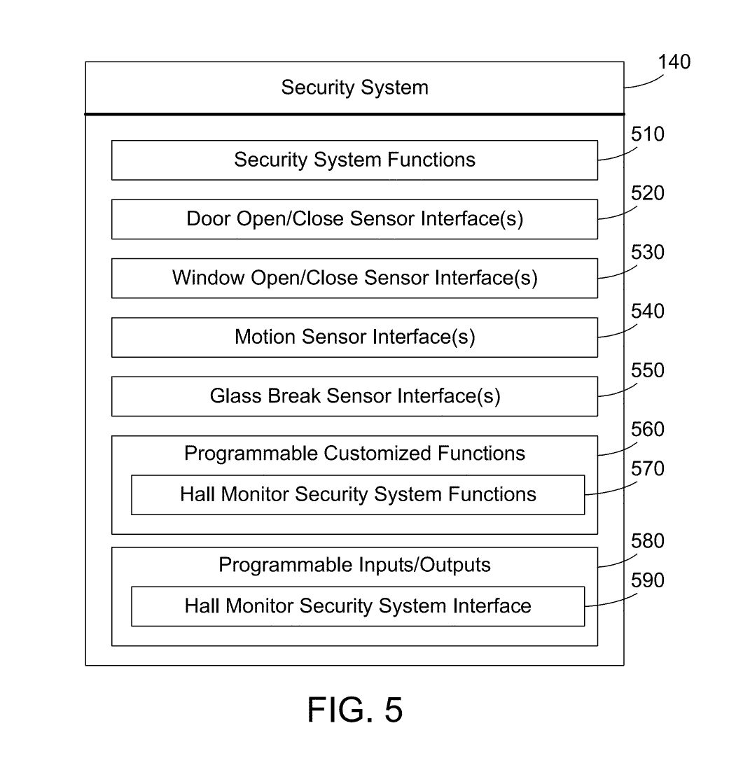

As discussed above with reference to FIG. 1, security system 140 is an optional system that could be integrated into the hall monitor system 100. One suitable example for security system 140 is shown in FIG. 5 to include security system functions 510, one or more door open/close sensor interfaces 520, one or more window open/close sensor interfaces 530, one or more motion sensor interfaces 540, and one or more glass break sensor interfaces 540. Note the interfaces 420, 430, 440 and 450 are software interfaces that are available for use, and do not imply these interfaces are always needed or used for each installation. The security system functions 510 and interfaces 520, 530, 540 and 550 represent the native functions provided by the security system 140, which can include any suitable security system functions, whether currently known or developed in the future. Security system 140 may also include any other type or number of interfaces, whether currently known or developed in the future. The programmable customized functions 560 are customized functions defined in the security system 140 that provide hall monitor security system functions 570, and the programmable inputs/outputs 580 provide the hall monitor security system interface 590.

The fire alarm system 150 in FIG. 1 is shown coupled to the access control system 130. This allows a fire alarm generated by the fire alarm system 150 to be detected by the access control system 140, which can then initiate a fire event in the hall monitor system, which will cause the hall monitor system to perform appropriate corresponding actions for the fire event, such as providing an announcement over the PA system and unlocking all of the doors.

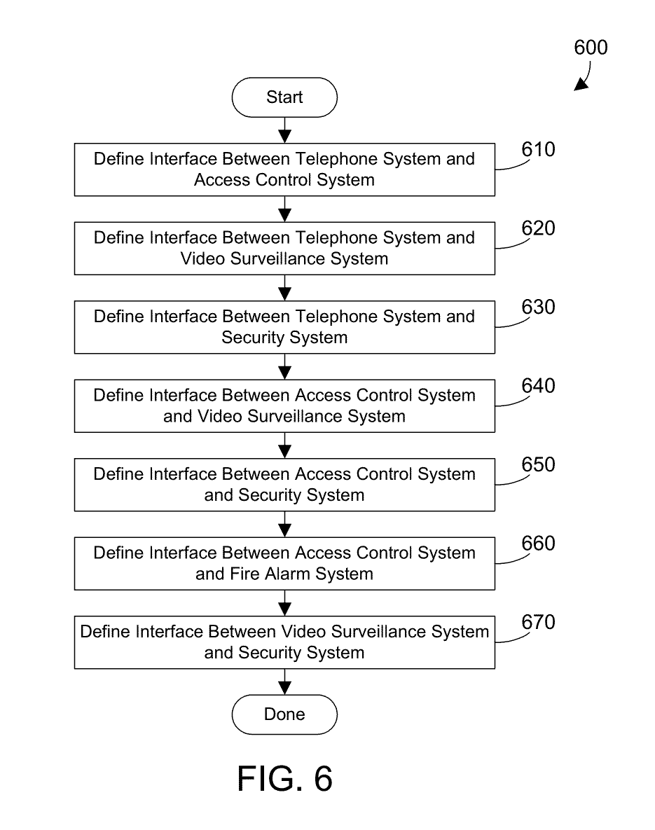

The design of a hall monitor system begins by defining interfaces between the various component systems. Method 600 in FIG. 6 shows one suitable method for defining interfaces. An interface between the telephone system and the access control system is defined (step 610). An interface between the telephone system and the video surveillance system is also defined (step 620). An interface between the telephone system and the security system is defined (step 630). An interface between the access control system and the video surveillance system is defined (step 640). The interface between the access control system and the security system is defined (step 650). An interface between the access control system and the fire alarm system is defined (step 660). An interface between the video surveillance system and the security system is defined (step 670). Method 600 is then done.

Note the interfaces defined in FIG. 6 can be any suitable hardware, software, or combination. When using off-the-shelf component systems, such as an Asterisk telephone system, a video surveillance system by Salient Systems, and an access control system by DSX Access Systems, Inc., the interfaces could be relays that connect a programmable input/output on one system to a programmable input/output on another system. Suitable relays could include, for example, Xorcom Astribank relays that provide input/output pairs. These relays provide bidirectional communication, and can close or open a circuit pair to an associate subsystem. In the alternative, some of the interfaces may be software only, such as APIs that allow different subsystems to inter-communicate.

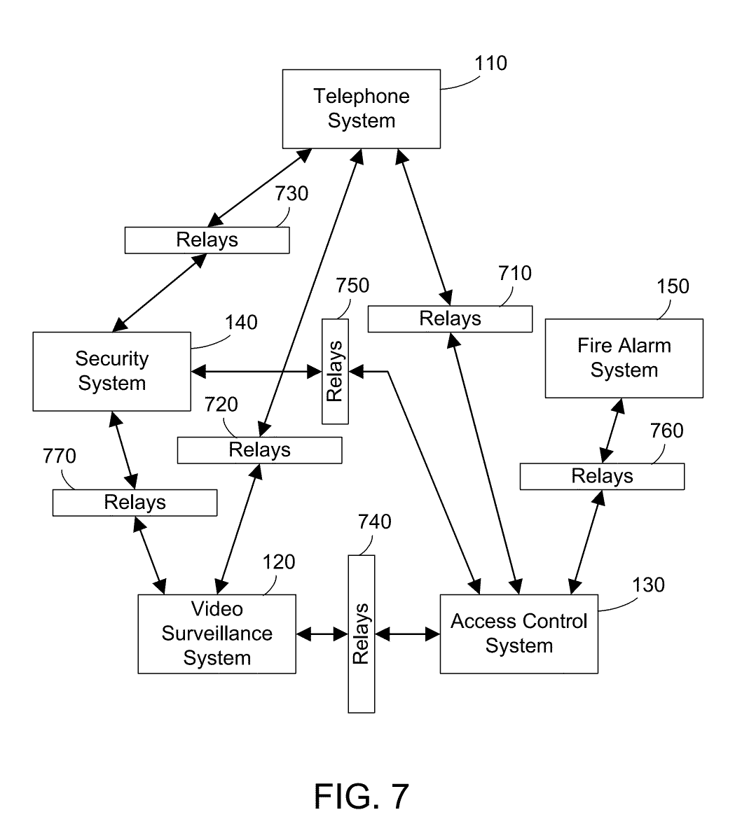

FIG. 7 shows a specific implementation where different relays are provided for the physical interfaces between systems. Note the reference designators for each set of relays in FIG. 7 corresponds to a step in method 600 shown in FIG. 6. Thus, step 610 in FIG. 6 provides relays 710 in FIG. 7; step 620 in FIG. 6 provides relays 720 in FIG. 7; step 630 in FIG. 6 provides relays 730 in FIG. 7; step 640 in FIG. 6 provides relays 740 in FIG. 7; step 650 in FIG. 6 provides relays 750 in FIG. 7; step 660 in FIG. 6 provides relays 760 in FIG. 7; and step 670 in FIG. 6 provides relays 770 in FIG. 7. The relays shown in FIG. 7 provide physical connections from programmable inputs/outputs in one subsystem to programmable inputs/outputs on the other subsystems, thus allowing programmable customized functions to be defined in each subsystem that defines how each subsystem interacts with respect to its programmable inputs/outputs. Of course, the some or all of the relays shown in FIG. 7 could be replaced with any other suitable interface, whether currently known or developed in the future. For example, the interface between the access control system and the video surveillance system could be a network interface, as discussed in more detail below.

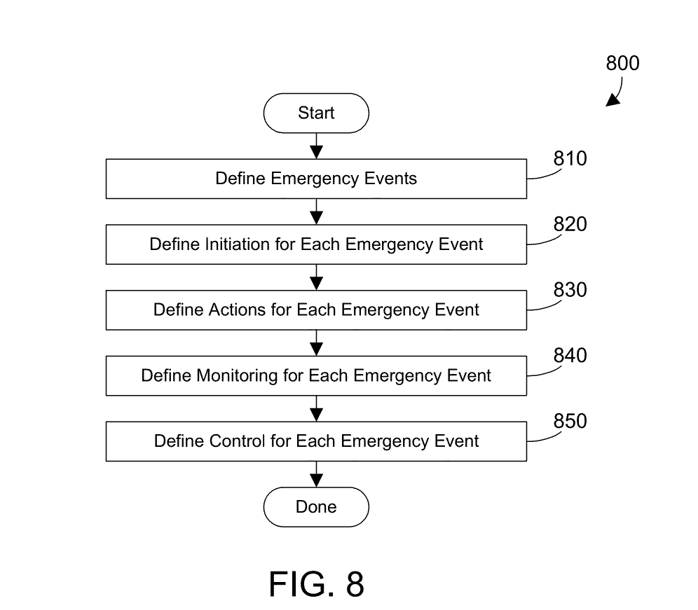

With the interfaces defined as shown in FIGS. 6 and 7, now the programming of the customized functions can begin. First, the desired functions of the hall monitor system are defined, as shown in method 800 in FIG. 8. One or more emergency events are defined (step 810). Initiation for each emergency event is defined (step 820). Actions for each emergency event are defined (step 830). Monitoring for each emergency event is defined (step 840). Control for each emergency event is defined (step 850). Method 900 is then done.

Method 800 in FIG. 8 in conjunction with the system in FIGS. 1-4 thus discloses a method for handling emergency events, the method comprising: providing a telephone system that provides a plurality of telephony functions; providing a video surveillance system that provides at least one camera interface coupled to at least one camera and provides a plurality of video surveillance functions; providing an access control system that provides at least one door lock interface to a plurality of door locks and provides a plurality of access control functions; providing a plurality of interfaces between the telephone system, the video surveillance system, and the access control system; defining a plurality of emergency events; programming a first plurality of customized functions in the telephone system for the plurality of emergency events; programming a second plurality of customized functions in the video surveillance system for the plurality of emergency events; and programming a third plurality of customized functions in the access control system for the plurality of emergency events.

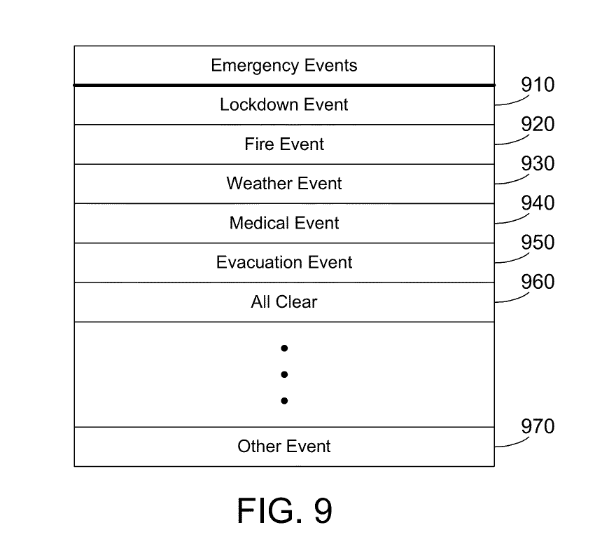

Suitable examples for emergency events defined in step 810 in FIG. 8 are shown in FIG. 9. Emergency events could include a lockdown event 910, a fire event 920, a weather event 930, a medical event 940, an evacuation event 950, an all clear event 960, and other event 970. A lockdown event 910 could occur when an armed person is spotted on the premises. A fire event 920 could occur when the fire alarm system 150 initiates a fire alarm. A weather event 930 can include a tornado warning, a lightening warning, a flood warning, etc. An evacuation event 950 could include a hazardous substance warning, etc. The all clear event 960 can be initiated to terminate an existing emergency event. The emergency events in FIG. 9 are shown by way of example, and any suitable emergency event could be defined for the hall monitor system disclosed and claimed herein.

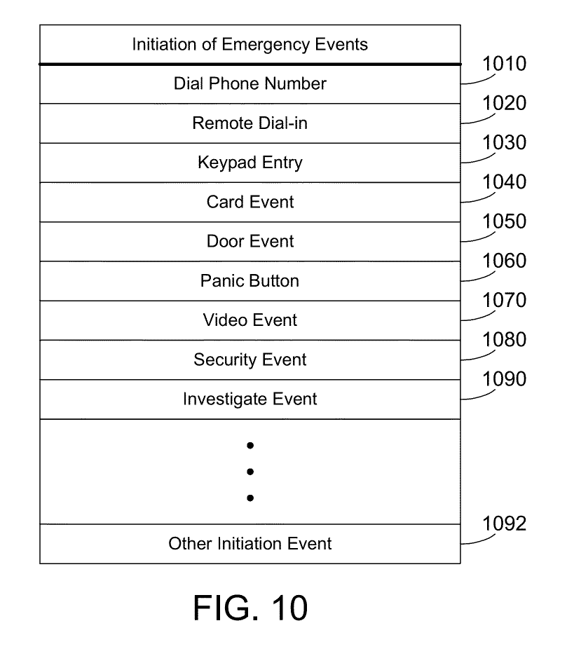

Suitable examples for initiation of emergency events defined in step 820 in FIG. 8 are shown in FIG. 10. Initiation of emergency events could include dialing a phone number 1010, remote dial-in 1020, keypad entry 1030, card event 1040, door event 1050, panic button 1060, video event 1070, security event 1080, investigate event 1090, and other initiation event 1092. Dialing a phone number 1010 could initiate different events in different ways. For example, dialing a specific extension on the telephone system could initiate different events. Thus, different extensions could correspond to different emergency events. If a student has a medical issue, a teacher could dial an extension corresponding to a medical event, which would initiate the medical emergency event for the hall monitor system. If a teacher or student sees an armed intruder, an extension corresponding to a lockdown event could be dialed, which would initiate the lockdown emergency event for the hall monitor system. Dialing 911 from a classroom phone could also result in initiation of an emergency event for the hall monitor system. Because it is not clear from the detection of a 911 call what kind of emergency has occurred, dialing 911 could initiate an investigate event 1090, which would notify appropriate people that 911 was dialed from a specified location so they can investigate the nature of the emergency. Once the nature of the emergency is determined, the appropriate emergency event could be initiated using any suitable initiation event.

Remote dial-in 1020 allows initiating emergency events remotely. Thus, let's assume an intruder is detected by the security system late one night when nobody is at the school. A person with authorized remote access could dial-in to the telephone system, and initiate any emergency event by keying in an appropriate code via a telephone keypad.

Emergency events can also be initiated via keypad entry 1030. Of course, this assumes the access control system includes keypads. Different codes on the keypad can be defined that can initiate different emergency events. This is similar to the initiation of emergency events via remote dial-in 1020 discussed above. By entering a defined code on a keypad, a person could initiate an emergency event in the hall monitor system.

A card event 1040 can also initiate emergency events. Of course, this assumes the access control system includes card readers. Any suitable card reader could be used, including card readers that read magnetic stripes on a card, optical card readers, and non-contact card readers that communication with the card via a wireless interfaces, such as via radio frequency identification (RFID). For example, a teacher in a school could be given different cards that are labeled with the emergency events they initiate, and the teacher could then initiate an emergency event by having a corresponding card read by a card reader.

A door event 1050 can also initiate emergency events. For example, an area could be defined as off-limits where nobody is allowed to go without authorization. If a door to the secure area is opened without the person being authorized, an emergency event could be initiated. Any suitable door event could initiate an emergency event in the hall monitor system.

A panic button 1060 could initiate emergency events. A panic button could be a normally-open single-pole momentary push-button switch that could be connected, for example, to the telephone system, access control system, or security system to initiate an emergency event. Note that different panic buttons could be provided to initiate different emergency events. When a person wants to initiate an emergency event with a panic button, the person simply pushes the push-button switch to initiate the emergency event. For example, a front office at a school could have a panic button to initiate a lockdown event should a suspicious person be seen.

A video event could also initiate an emergency event. One example of a video event is detecting motion on a particular camera where nobody is supposed to be. Thus, if a person is detected by motion on a video camera in an outside stairwell during classes when all the doors are locked and the only authorized access is through the front office, this video event could initiate a corresponding emergency event.

A security event could initiate an emergency event. A security event can include any event triggered by the security system, including the opening of a door, the opening of a window, the triggering of a motion sensor or glass break sensor, etc.

The initiation of emergency events shown in FIG. 10 are examples for the purpose of illustration, and are not limiting of the disclosure and claims herein. Any emergency event could be initiated in any suitable way, whether currently known or developed in the future.

Note the initiation of emergency events shown in FIG. 10 could be defined on different systems. Thus, initiation of emergency events in 1010 and 1020 could be defined on the telephone system. The initiation of emergency events in 1030, 1040 and 1050 could be defined on the access control system. The initiation of an emergency event via a panic button 1060 could be defined on the telephone system, access control system, or security system. The initiation of a video event 1070 could be defined on the video surveillance system. The initiation of a security event 1080 could be defined on the security system. The initiation of the investigate event 1090 could be defined on the telephone system. The specific examples given in this paragraph are given by way of illustration and are not limiting. Any defined emergency event can be initiated in any suitable way on any subsystem in the hall monitor system.

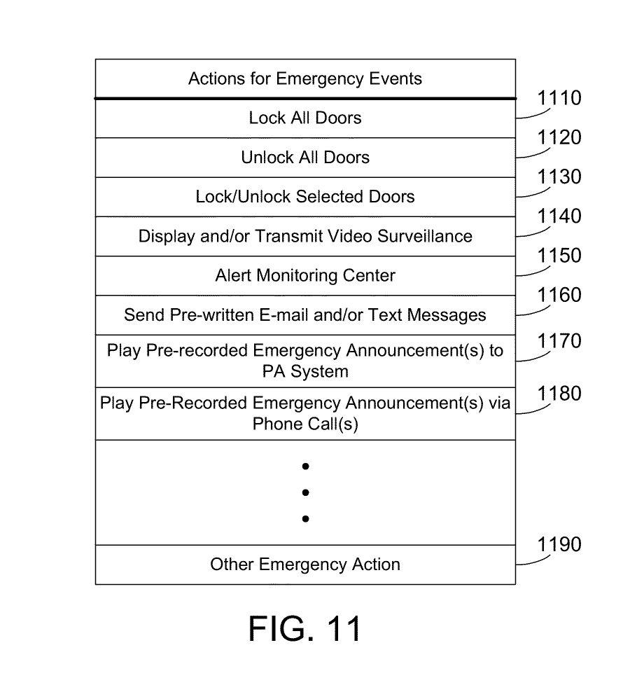

Suitable examples of actions for emergency events defined in step 830 in FIG. 8 are shown in FIG. 11. These actions include lock all doors 1110, unlock all doors 1120, lock or unlock selected doors 1130, display and/or transmit video surveillance 1140, alert monitoring center 1150, send pre-written e-mail and/or text messages 1160, play one or more pre-recorded emergency announcements to a PA system 1170, play one or more pre-recorded emergency announcements via one or more phone calls 1180, and other emergency action 1190. The lock all doors 1110 could be performed for a corresponding emergency event, such as a lockdown event. Unlock all doors 1120 could be performed for a corresponding emergency event, such as a fire event or an evacuation event. Lock and/or unlock selected doors could be performed for a corresponding emergency event. For example, a lockdown could lock all doors, and when emergency responders arrive, a door could be selectively unlocked to allow the emergency responders to enter. Display and/or transmit video surveillance 1140 could include displaying video surveillance in any suitable location, or transmitting the video surveillance images to an appropriate device. Thus, when police respond to an emergency event, video surveillance images could be transmitted to handheld devices the police use, giving them the ability to see what's happening at the facility.

Alert monitoring center 1150 could include the security system alerting its remote monitoring center of the emergency event. The remote monitoring center could then respond in a predetermined way, such as calling the police. Sending pre-written e-mail and/or text messages 1160 can include sending messages to any suitable person or entity, including personnel on-premises at the facility, or personnel outside the facility. Playing one or more pre-recorded emergency announcements to a PA system 1170 could include playing any suitable announcement, which could include any suitable announcement, such as announcements that direct people to stay where they are, to exit immediately, to go to a designated safe location, etc. Playing one or more pre-recorded emergency announcements via one or more phone calls 1180 can include making calls to any suitable person or organization. For example, the hall monitor system, upon detection of a lockdown event, could call 911 and play the emergency announcement “School XYZ is in Lockdown. Please send police immediately.” The messages sent at 1160, 1170 and 1180 are collectively referred to herein as mass notification messages.

The actions for emergency events shown in FIG. 11 are examples for the purpose of illustration, and are not limiting of the disclosure and claims herein. Any action for an emergency event could be included, whether currently known or developed in the future.

Note the actions for emergency events shown in FIG. 11 could be performed by different systems. Thus, locking all doors 1110, unlocking all doors 1120, and locking and/or unlocking selected doors 1130 could be performed by the access control system. Displaying and/or transmitting video surveillance 1140 could be performed by the video control system. Alert monitoring center 1150 could be performed by the security system. Sending pre-written messages 1160 or playing pre-recorded emergency announcements 1170 and 11809 could be performed by the telephone system. The specific examples given in this paragraph are given by way of illustration and are not limiting. Any desired action for an emergency event can be performed in any suitable way by any system in the hall monitor system that supports that action.

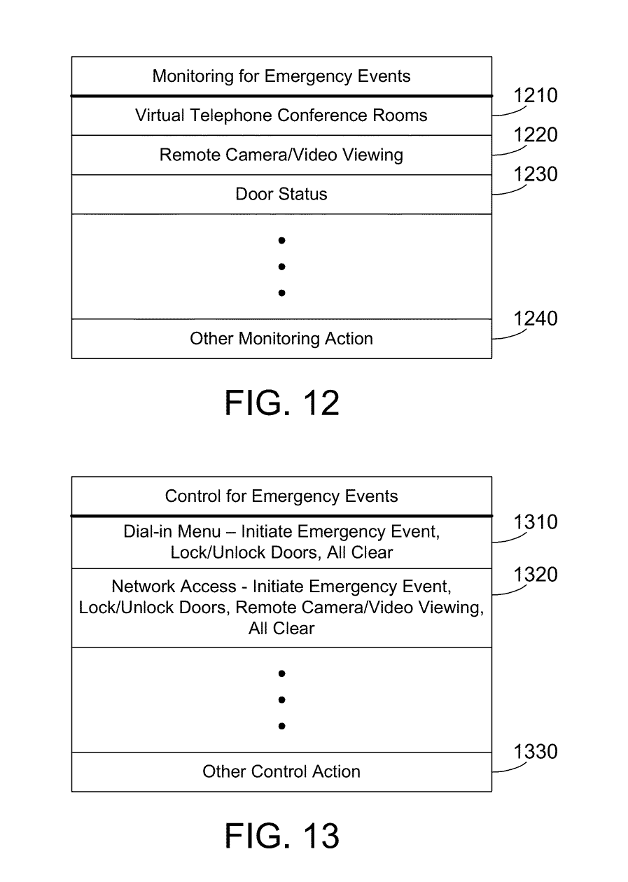

Suitable examples of monitoring for emergency events defined in step 840 in FIG. 8 are shown in FIG. 12. Monitoring for emergency events can include virtual telephone conference rooms 1210, remote camera/video viewing 1220, and door status 1230. Virtual telephone conference rooms 1210 provide a way for people to interact during an emergency event. Thus, if a school is in lockdown, school officials could communicate with police and people at different locations in the facility via a virtual conference room, which would allow various people at different locations both within the facility and external to the facility to intercommunicate. Remote camera/video viewing 1220 allows viewing images or video from any camera in the video surveillance system remotely. Door status 1230 provides the status (open or closed) for each door controlled by the access control system. The monitoring for emergency events can be both statically and dynamically defined. Thus, when an emergency event is initiated, the views of some or all cameras could be displayed to a particular computer system in the facility, along with the door status. Of course, the remote camera/video viewing 1220 and door status 1230 could also be dynamically sent to any suitable location or device on-demand, such as a tablet computer used by emergency responders.

The monitoring for emergency events shown in FIG. 12 are examples for the purpose of illustration, and are not limiting of the disclosure and claims herein. Any monitoring for an emergency event could be included, whether currently known or developed in the future.

Note the monitoring for emergency events shown in FIG. 12 could be performed by different systems. Thus, the virtual telephone conference rooms 1210 could be provided by the telephone system. The remote camera/video viewing 1220 could be provided by the video surveillance system. The door status 1230 could be provided by the access control system. The specific examples given in this paragraph are given by way of illustration and are not limiting. Any desired monitoring for an emergency event can be performed in any suitable way by any system in the hall monitor system that supports that monitoring function.

Suitable examples of control for emergency events defined in step 850 in FIG. 8 are shown in FIG. 13. Control for emergency events can include a dial-in menu 1310 that allows a user to initiate an emergency event, to lock/unlock individual doors or all doors, and to initiate the All Clear emergency event to indicate the end of the previously-initiated emergency event. Control for emergency events can also include network access 1320 that can provide the same or similar functions as the dial-in menu, and can additionally provide for remote/video camera viewing at the remote location.

The control for emergency events shown in FIG. 13 are examples for the purpose of illustration, and are not limiting of the disclosure and claims herein. Any control for an emergency event could be included, whether currently known or developed in the future.

Note the control for emergency events shown in FIG. 13 could be performed by different systems. Thus, the dial-in menu 1310 could be provided by the telephone system. The network access 1320 could be provided by the telephone system, the access control system, or the video surveillance system via the Internet. The specific examples given in this paragraph are given by way of illustration and are not limiting. Any desired control for an emergency event can be performed in any suitable way by any system in the hall monitor system that supports that control function.

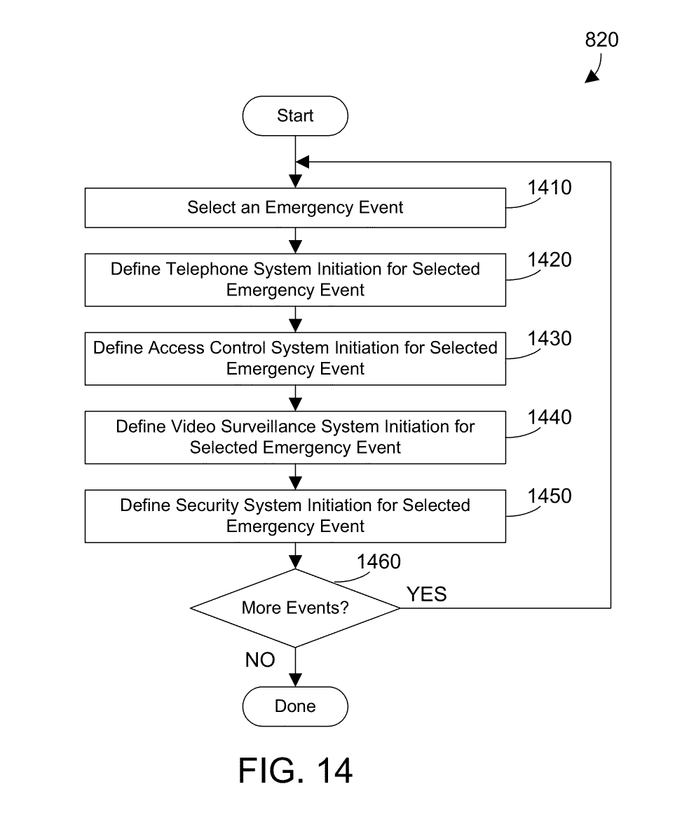

Referring to FIG. 14, a method 820 is one suitable implementation for step 820 shown in FIG. 8, which defines how each emergency event can be initiated by the various subsystems in the hall monitor system. An emergency event is selected (step 1410). When the telephone system needs to be able to initiate the selected emergency event, the telephone system initiation for the selected emergency event is defined (step 1420). When the access control system needs to be able to initiate the selected emergency event, the access control system initiation for the selected emergency event is defined (step 1430). When the video surveillance system needs to be able to initiate the selected emergency event, the video surveillance system initiation for the selected emergency event is defined (step 1440). When the security system needs to be able to initiate the selected emergency event, the security system initiation for the selected emergency event is defined (step 1450). When there are more emergency events to process (step 1460=YES), method 820 returns to step 1410 and repeats the steps for the next emergency event. This process continues until there are no more emergency events to process (step 1460=NO). Method 820 is then done. Method 820 thus provides a way to define how the various subsystems in the hall monitor system can initiate each defined emergency event.

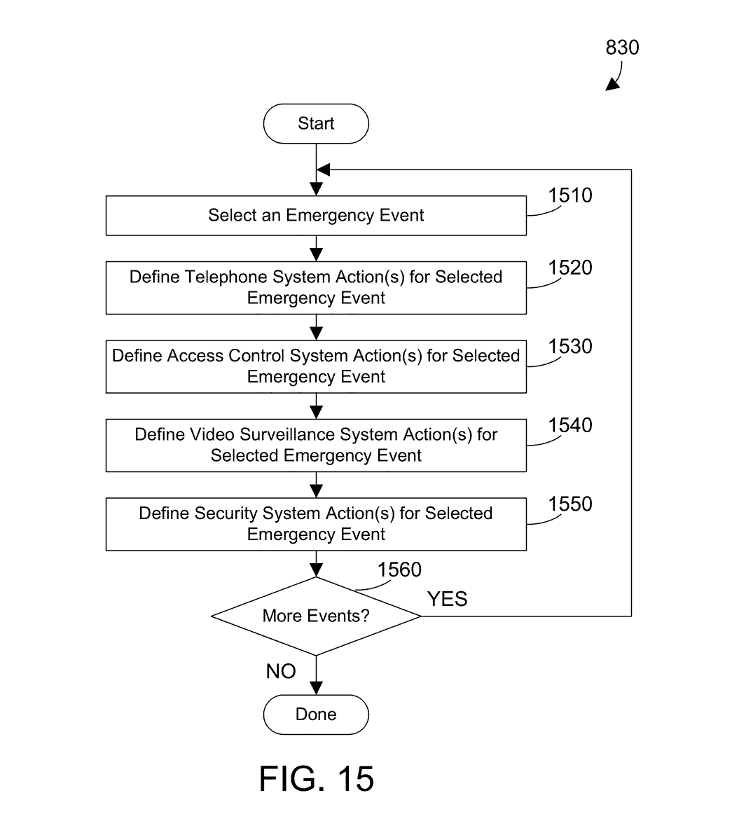

Referring to FIG. 15, a method 830 is one suitable implementation for step 830 shown in FIG. 8, which defines actions for each emergency event by the various subsystems in the hall monitor system. An emergency event is selected (step 1510). When the telephone system needs to perform an action for the selected emergency event, the one or more telephone system actions for the selected emergency event are defined (step 1520). When the access control system needs to perform one or more actions for the selected emergency event, the one or more access control system actions for the selected emergency event are defined (step 1530). When the video surveillance system needs to perform one or more actions for the selected emergency event, the one or more actions by the video surveillance system for the selected emergency event are defined (step 1540). When the security system needs to perform one or more actions for the selected emergency event, the one or more security system actions for the selected emergency event are defined (step 1550). When there are more emergency events to process (step 1560=YES), method 830 returns to step 1510 and repeats the steps for the next emergency event. This process continues until there are no more emergency events to process (step 1560=NO). Method 830 is then done. Method 830 thus provides a way to define how the various subsystems in the hall monitor system can perform one or more actions for each defined emergency event.

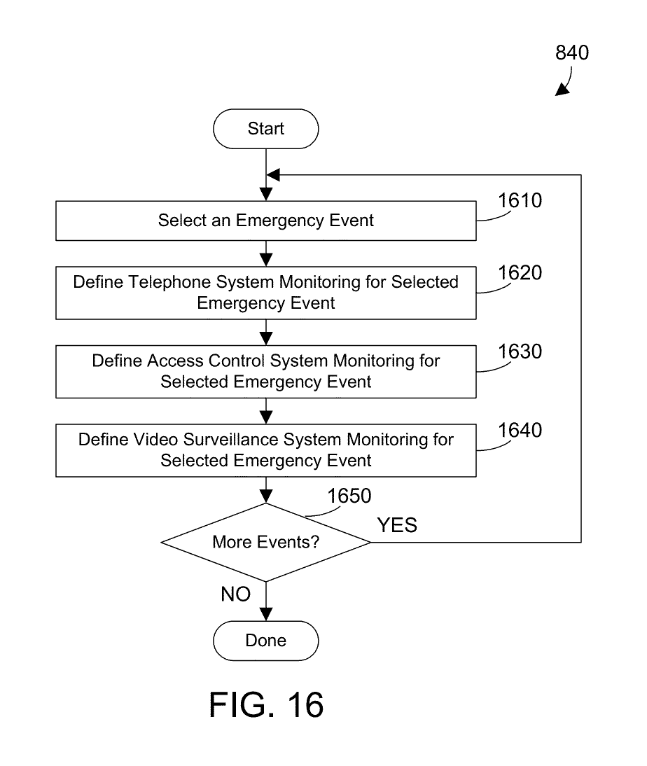

Referring to FIG. 16, a method 840 is one suitable implementation for step 840 shown in FIG. 8, which defines monitoring for each emergency event by the various subsystems in the hall monitor system. An emergency event is selected (step 1610). When the telephone system needs to perform monitoring for the selected emergency event, the telephone system monitoring for the selected emergency event is defined (step 1620). When the access control system needs to perform monitoring for the selected emergency event, the access control system monitoring for the selected emergency event is defined (step 1630). When the video surveillance system needs to perform monitoring for the selected emergency event, the monitoring by the video surveillance system for the selected emergency event is defined (step 1640). When there are more emergency events to process (step 1650=YES), method 840 returns to step 1610 and repeats the steps for the next emergency event. This process continues until there are no more emergency events to process (step 1650=NO). Method 840 is then done. Method 840 thus provides a way to define how the various subsystems in the hall monitor system can perform monitoring for each defined emergency event.

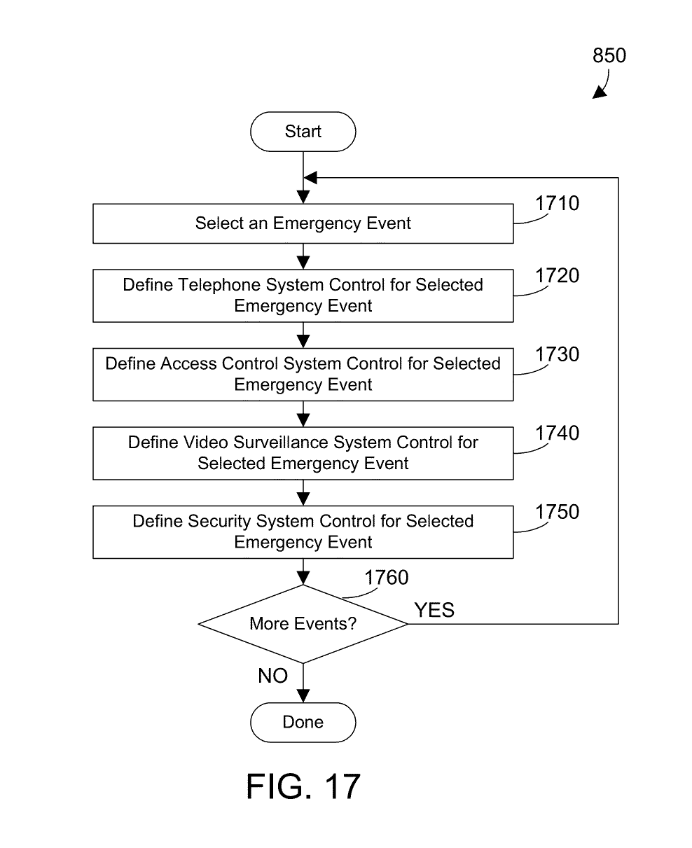

Referring to FIG. 17, a method 850 is one suitable implementation for step 850 shown in FIG. 8, which defines control for each emergency event by the various subsystems in the hall monitor system. An emergency event is selected (step 1710). When the telephone system needs to perform control for the selected emergency event, the telephone system control for the selected emergency event is defined (step 1720). When the access control system needs to perform control for the selected emergency event, the access control system control for the selected emergency event is defined (step 1730). When the video surveillance system needs to perform control for the selected emergency event, the control by the video surveillance system for the selected emergency event is defined (step 1740). When the security system needs to perform control for the selected emergency event, the security system control for the selected emergency event is defined (step 1750). When there are more emergency events to process (step 1760=YES), method 850 returns to step 1710 and repeats the steps for the next emergency event. This process continues until there are no more emergency events to process (step 1760=NO). Method 850 is then done. Method 850 thus provides a way to define how the various subsystems in the hall monitor system can perform control for each defined emergency event.

While the methods shown in FIGS. 14-17 shows steps for the various subsystems, it will be understood that a step is only performed when a subsystem needs to be programmed to support the desired function. In some cases, steps will be skipped because there is no programming to perform on a particular subsystem for a particular function.

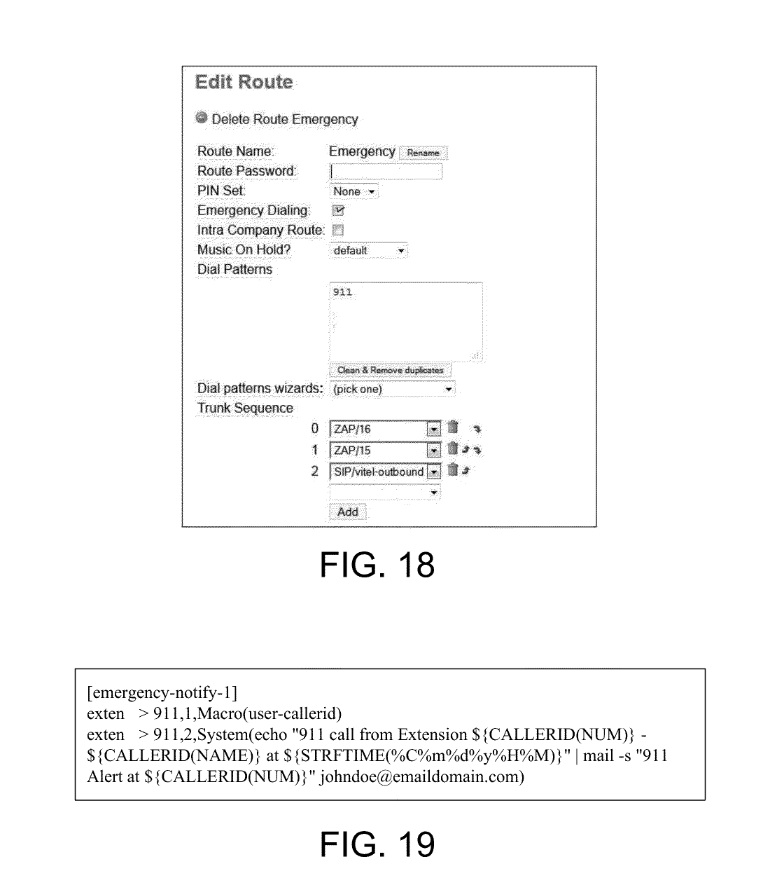

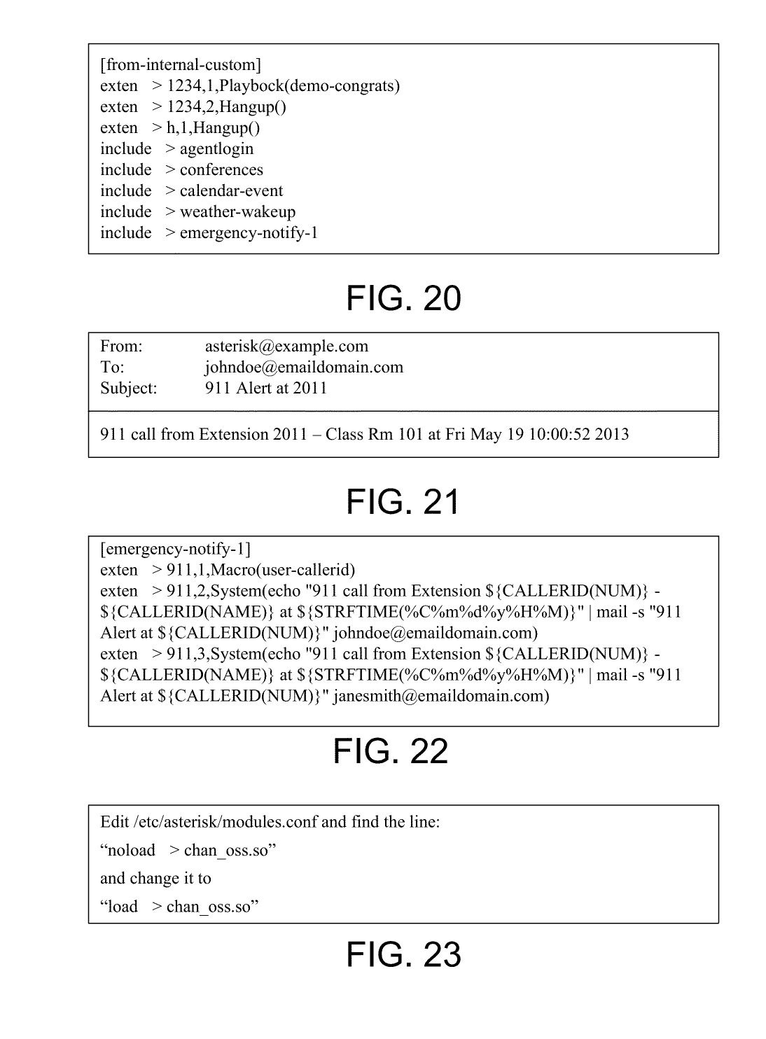

Examples of specific programming are shown in FIGS. 18-33 to illustrate how to program some of the functions of the hall monitor system using an Asterisk-based telephone system. Let's assume a function for an emergency event is to notify an emergency responder group when 911 has been dialed on an extension on the Asterisk-based PBX. This would allow, for example, the emergency responders to go to the location where 911 was dialed and manage the emergency until public emergency services personnel arrive. This notification could be provided via e-mail. FIG. 18 shows an Asterisk menu that allows defining a working 911 outbound route. The context in FIG. 19 is then added to /etc/asterisk/extension_custom.conf, replacing “911 call from Extension” with the preferred email text, “911 Alert at ” with the preferred e-mail subject line text and an e-mail address for sending an e-mail for the 911 alert. The e-mail address shown in FIGS. 19 and 21 is johndoe@emaildomain.com. Within /etc/asterisk/extension_custom.conf, include the context shown in FIG. 20. After reloading the Asterisk software, a 911 call from extension 2011 will produce the e-mail message to johndoe@emaildomain.com shown in FIG. 21. Note the example above will transmit to one e-mail address. On some e-mail servers, it is possible to create one address that will forward to multiple e-mail addresses. However, it is also possible to add additional e-mail addresses to the Asterisk system by adding additional lines of code, as shown by the addition of an entry in FIG. 22 that creates an e-mail message to janesmith@emaildomain.com. Of course, this code could be replicated for as many e-mail addresses as needed. Many e-mail systems include the capability of converting e-mails to text messages. This would allow an e-mail sent to a user to be automatically forwarded to the user's phone via text message.

Programming is now shown that allows automated public announcements over a PA system by the Asterisk telephone system in response to an emergency event. The example presented here assumes the telephone system includes a sound card that is connected to a PA system. The Asterisk telephone system is first configured to have dialable access from the telephone server to the external PA system. Using a sound card in the Asterisk system allows real-time paging, unlike many telephone systems that allows a user to dial an extension for a page, say a paging message, with the result that the paging message is delivered to the PA system sometime later. Because the output of a sound board is at a low level, it is preferably connected to an amplifier in the PA system. This is a common configuration in existing facilities, allowing the hall monitor system to leverage off of existing infrastructure such as a paging system with installed speakers.

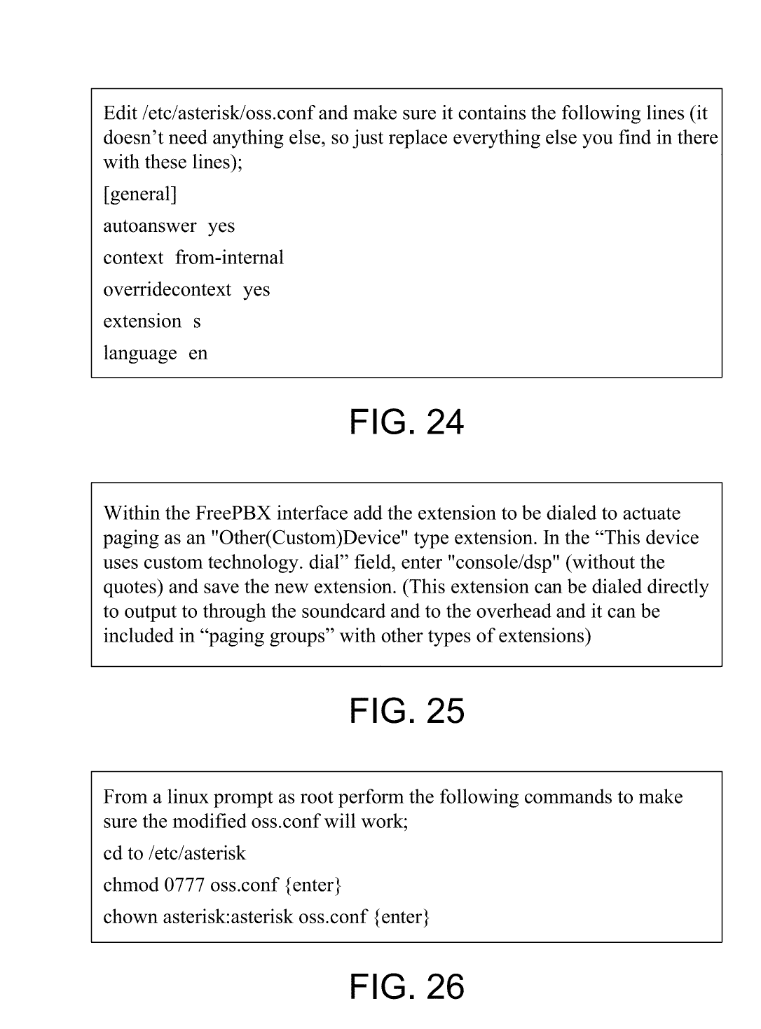

First, make sure the sound card is enabled in the computer system and functioning properly. Next, perform the steps shown in FIG. 23. Then perform the steps shown in FIG. 24. The steps in FIG. 25 are then performed. Then perform the steps in FIG. 26 from a Linux prompt. Then restart the Asterisk system. At this point you can dial the extension setup for paging and state a paging message. The paging message will come out of the sound card, which will result in the paging message being played over the PA system. Appropriate adjustments may then be made to the sound output level of the sound card and the sound output level of the PA system to achieve messages at a desired level of volume.

Now the programming is complete for creating a dial-able extension number that results in a page on the PA system, the Asterisk telephone system can be programmed to play pre-recorded emergency announcements over the PA system upon initiation of an emergency event, during an emergency event, or when an emergency event has ended. First, record the emergency announcements. One suitable format for the emergency announcements is .wav files in a 16-bit PCM encoded 8 KHz format. This can be done on a separate computer system using a microphone and an audio recording program. In the alternative, the emergency announcements could be recorded directly from a telephone handset using the System Recordings module in the Asterisk FreePBX module. Then put the audio files for the pre-recorded emergency announcements in an Asterisk-accessible directory, such as /var/lib/asterisk/sounds/custom with appropriate Linux permissions assigned, such as Octal 0755 user/group Asterisk.

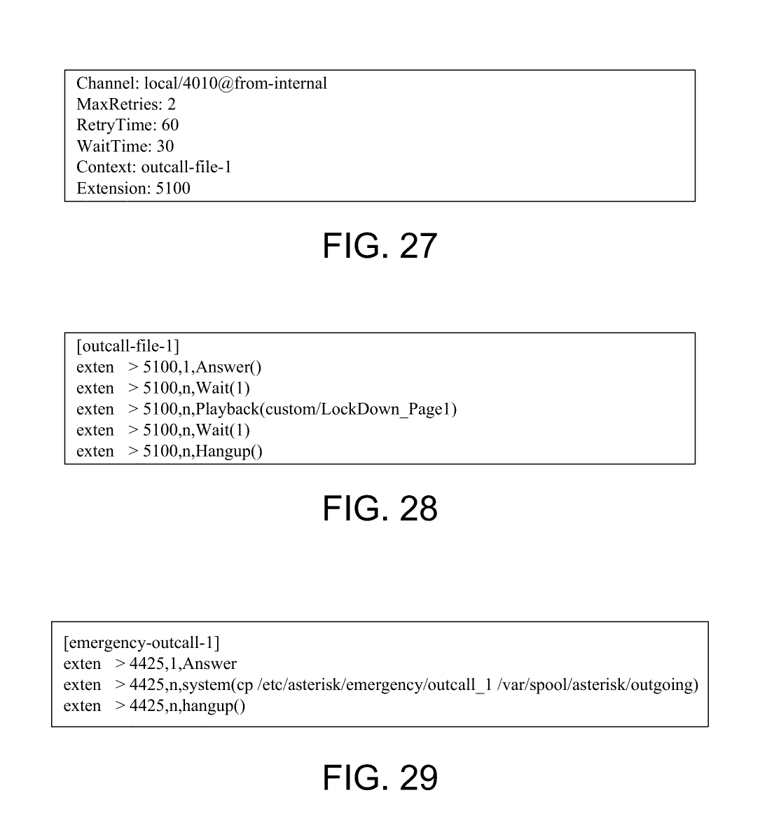

With the pre-recorded announcements in place, define the “outcall” file to feed instructions to the Asterisk “playback” command. An example of a suitable outcall file is shown in FIG. 27. Note there is preferably one context for each emergency announcement that needs to be played. Outcall files, such as the outcall file shown in FIG. 27, are stored in an Asterisk-accessible directory, such as /etc/asterisk/emergency with appropriate Linux permissions assigned, such as Octal 0755 user/group Asterisk.

These outcall files associate the “context”, “extension” and output “channel” with basic options at to timing and retry attempts. The next piece of programming in FIG. 28 defines extensions for the outcall-file-1, which specifies 5100 as the associated “extension” for this outcall file. The final component in playing this announcement over the selected output channel is the initiating “extension” and “context” within Asterisk. This can be done using the FreePBX graphical user interface in Asterisk, or within a file stored in /etc/asterisk/extension_custom.conf as shown in FIG. 29. Now when an emergency event that corresponds to outcall-file-1 is initiated, the Asterisk telephone system will automatically play the pre-recorded audio file for that emergency event over the PA system.

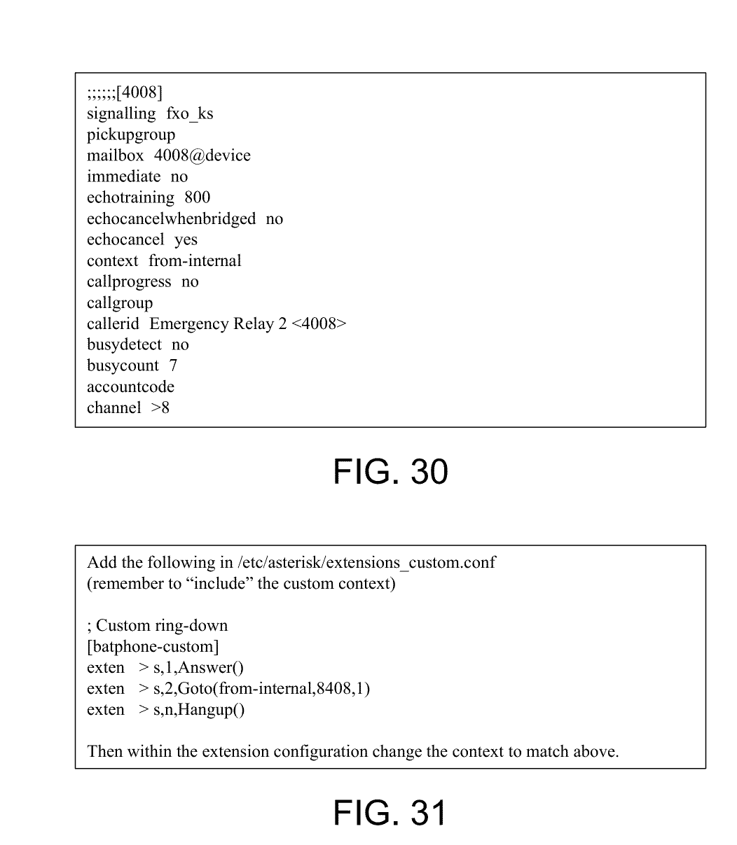

Initiation of an emergency event can be accomplished by different subsystems. Thus, programming is needed to define the interfaces between the subsystems. FIG. 30 shows sample programming to cause a programmable input/output on the telephone system to activate a relay on one of the telephone system interfaces to initiate an emergency event on a different system, such as the access control system or the video surveillance system. This programming could be in a configuration file store in /etc/asterisk/dandi_additional.conf, or could be created within the FreePBX graphical user interface provided by the Asterisk telephone system. The combination of programmable inputs/outputs and relays create a custom interface between subsystems that allow the subsystems to interact in a seamless manner.

Note that interaction via relays is not the only way the subsystems can communicate. For example, the access control system could use an application programming interface (API) to activate security cameras on the video surveillance system. The video surveillance system has the ability to activate the access control system in the same way. The disclosure and claims herein encompass any suitable interface between subsystems, including software only (such as API calls), a combination of hardware and software (such as programmable inputs/outputs that drive relays), or any other suitable interface.

The video surveillance system, access control system, or security system could initiate an emergency event, which would then need to be communicated to the telephone system so the telephone system can provide the mass notifications via the pre-written messages and pre-recorded announcements via the PA system or phone calls. This could be done, for example, using a Viking auto-dial module or using a Xorcom Astribank input relay. The Viking auto-dial module, in response to activation of the corresponding relay indicating an emergency event has been initiated, will dial a pre-programmed initiation code on an extension port on the telephone server. The Xorcom Astribank relay, when activated, will perform a “batdown” or “ring-down” function dialing a pre-programmed initial code via its extension port programmed on the appropriate port in the Asterisk telephone system. One example of suitable programming for this function is shown in FIG. 31. When the telephone system receives an initiation of an emergency event from any other subsystem, the telephone system will then performs its programmed actions and any associated monitoring or control functions for the emergency event, including playing an announcement on the PA system, sending e-mails or text messages, etc.

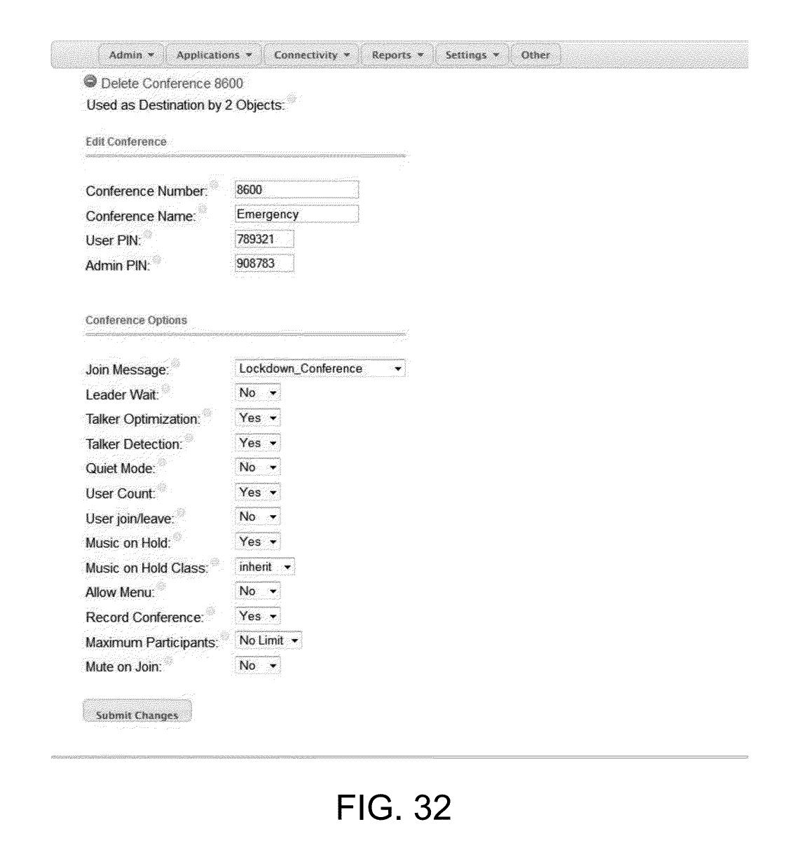

After an emergency event has been initiated, the telephone system provides various emergency event control functions. The initial messages sent to PA systems, e-mail or text messages can contain additional instructions to selected recipients directing them to a pre-programmed emergency conference room that uses the “Conference Bridge” function of Asterisk to provide the virtual conference room. This allows multiple participants to dial a telephone number that brings them into the emergency telephone conference in the virtual conference room after successfully entering a passcode. The virtual conference room allows information sharing and group management of the emergency event for personnel both inside the facility as well as those outside the facility. The virtual conference room could be configured using the FreePBX graphical user interface in the Asterisk telephone system, as shown in FIG. 32.

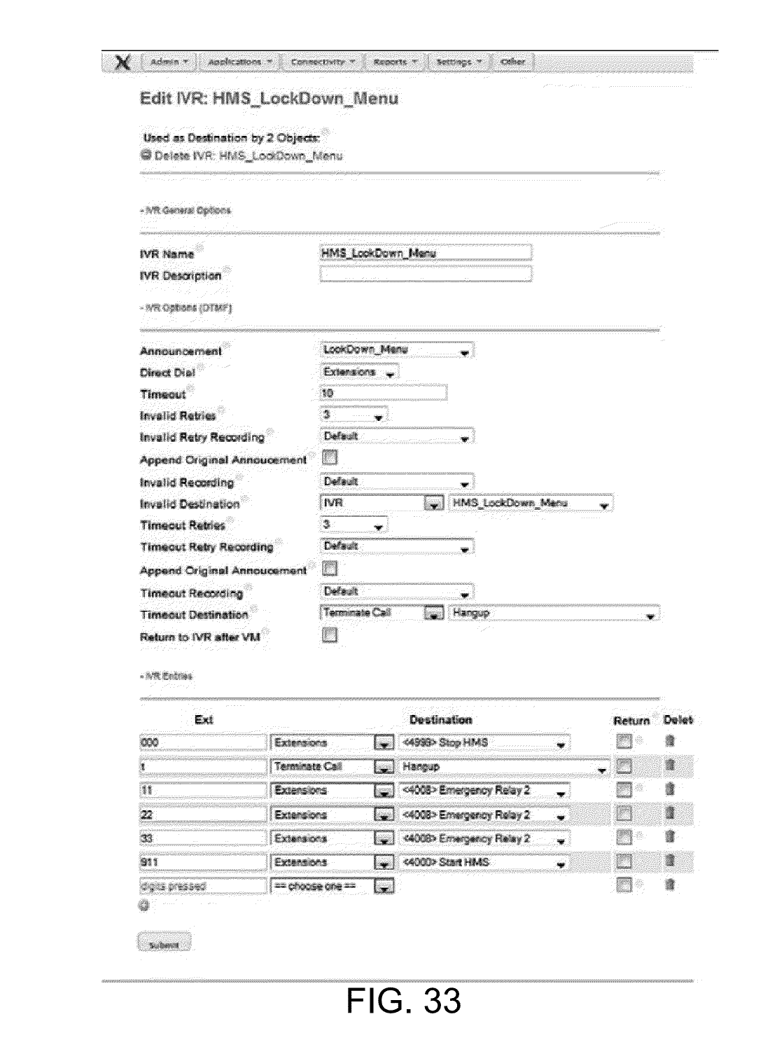

Emergency dial-in menus can also be provided by the Asterisk telephone system that allow controlling the hall monitor system from both the inside and outside the facility. These menus can be accessed by dialing an associated internal code or external phone number. After successfully entering an appropriate security code, the authorized user can initiate an emergency event, terminate an emergency event, and control various associate system features, such as locking or unlocking selected doors to allow first responders access to the facility. These menus could be configured using the FreePBX graphical user interface in the Asterisk telephone system, as shown in FIG. 33.

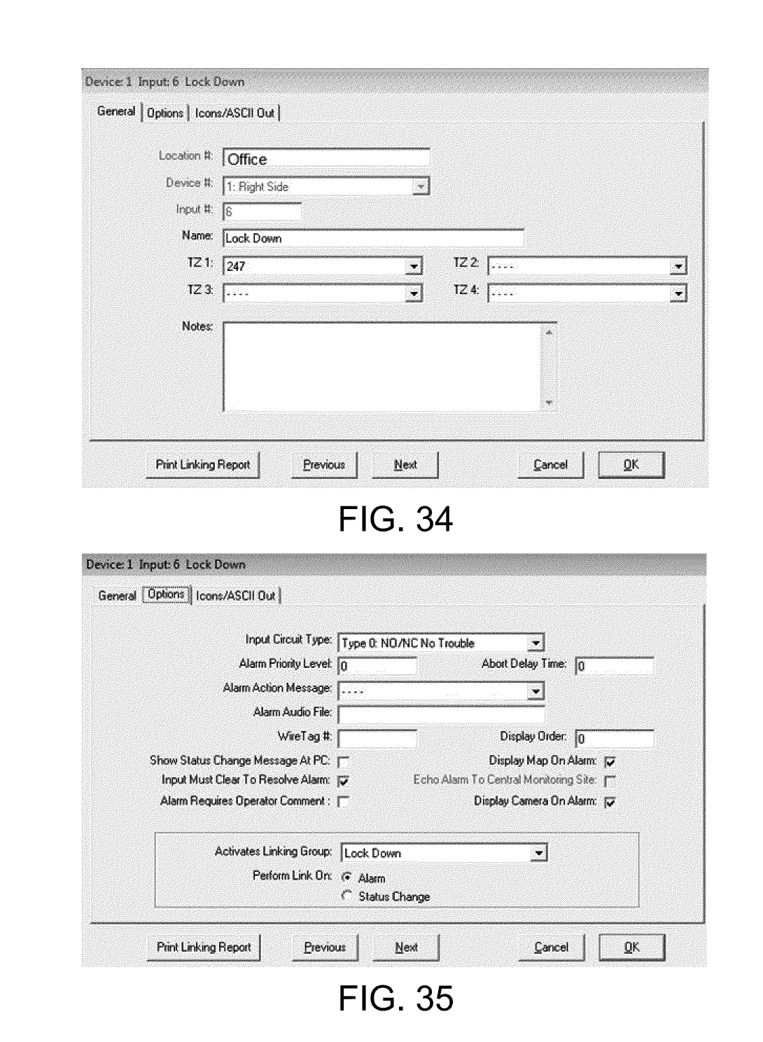

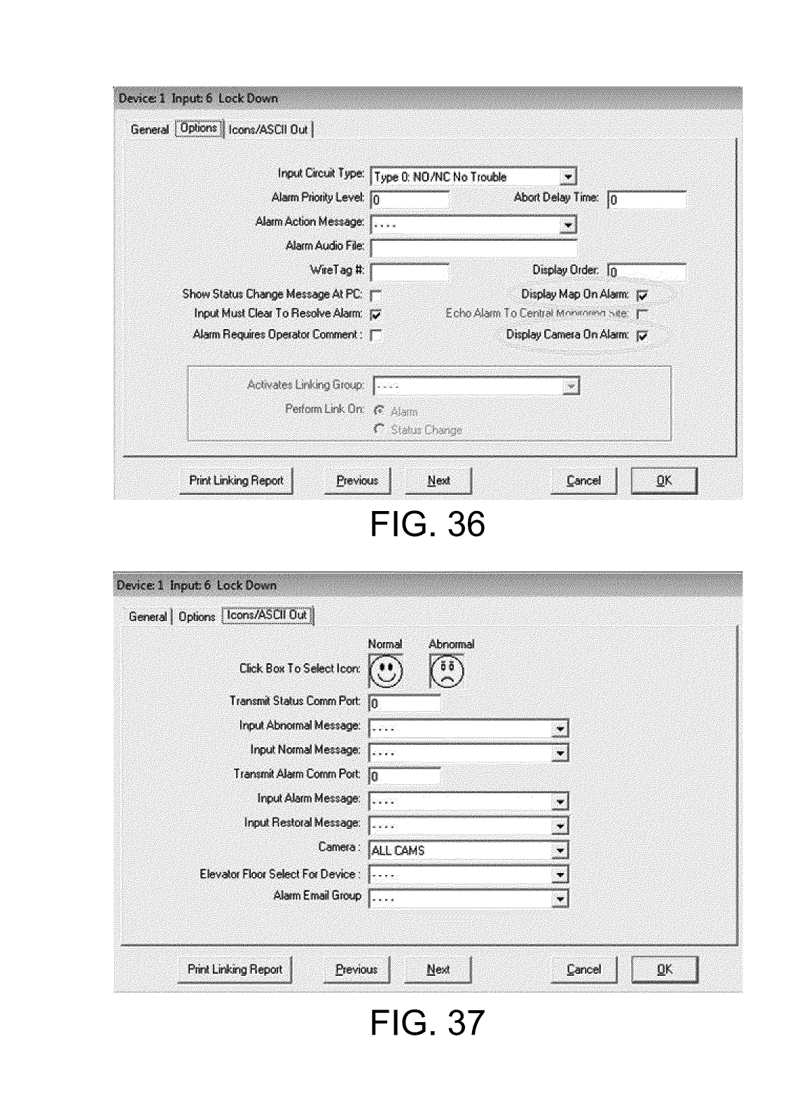

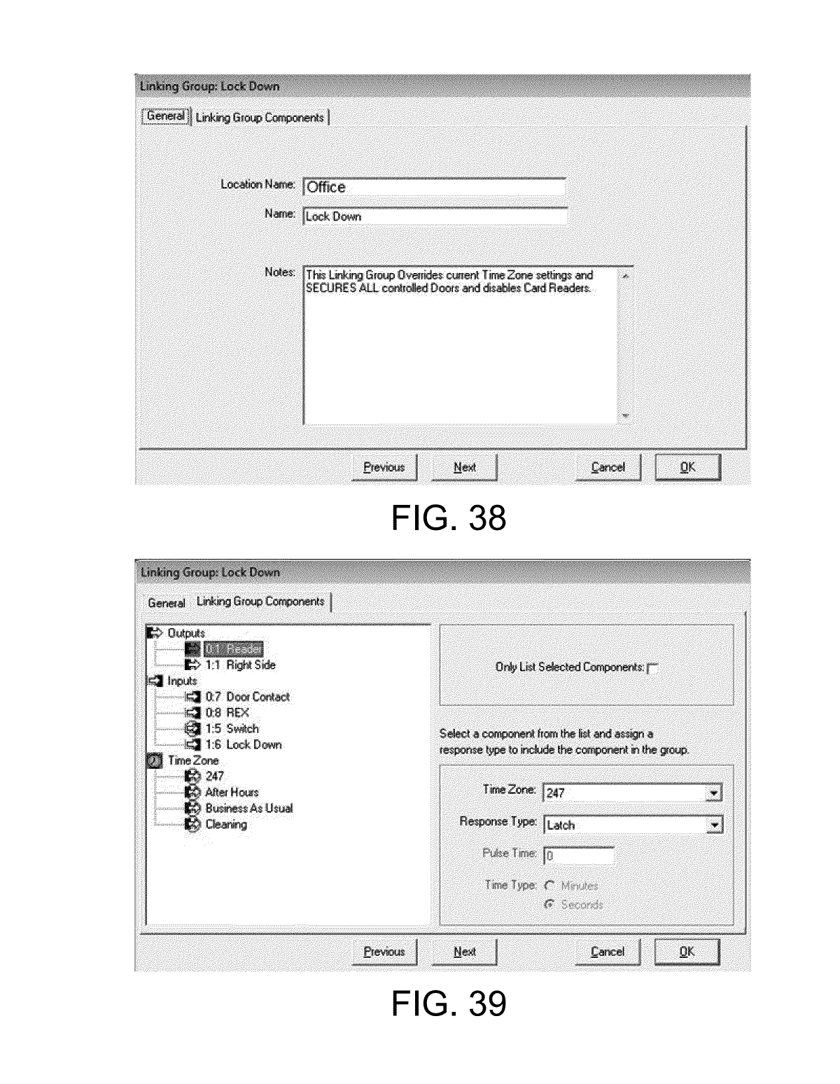

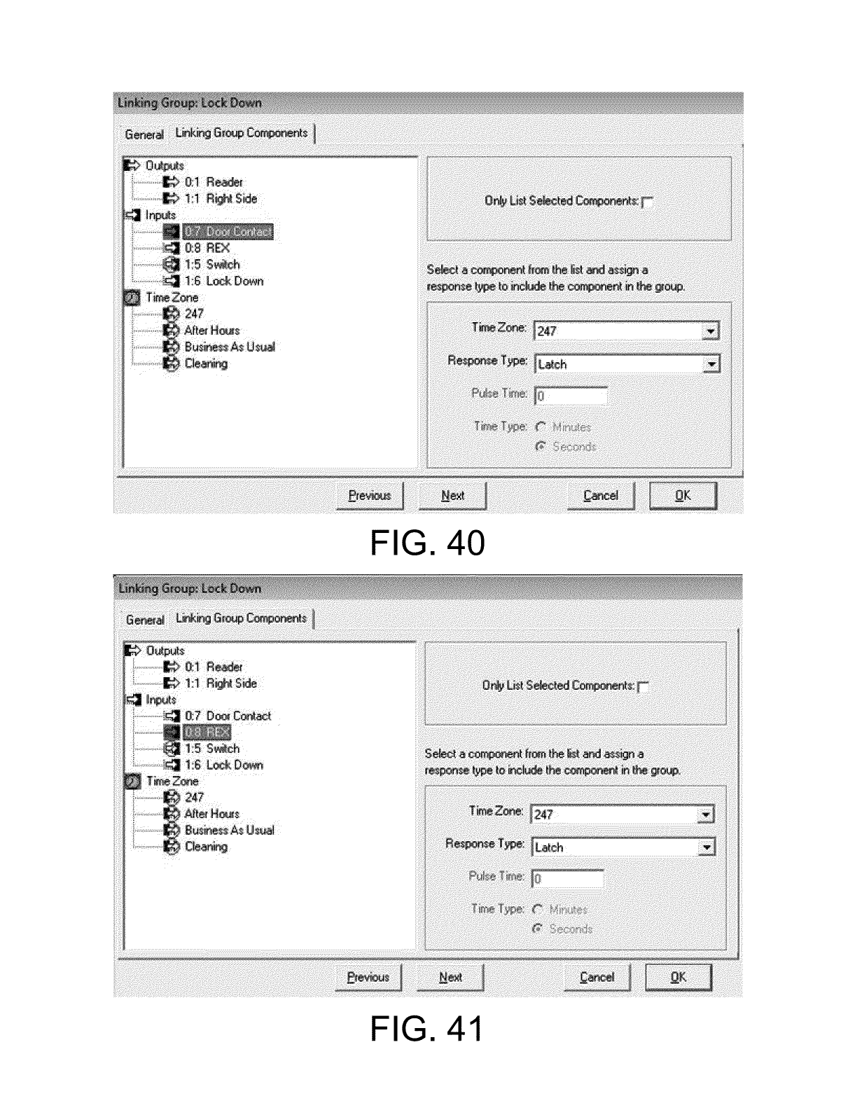

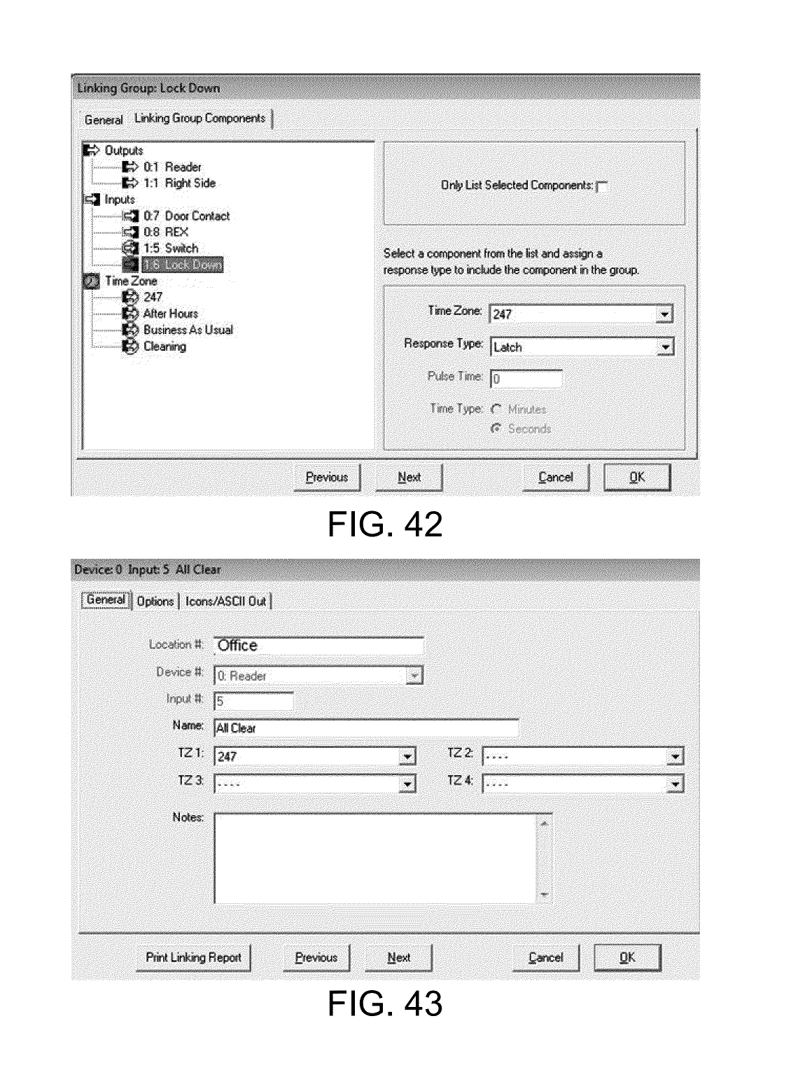

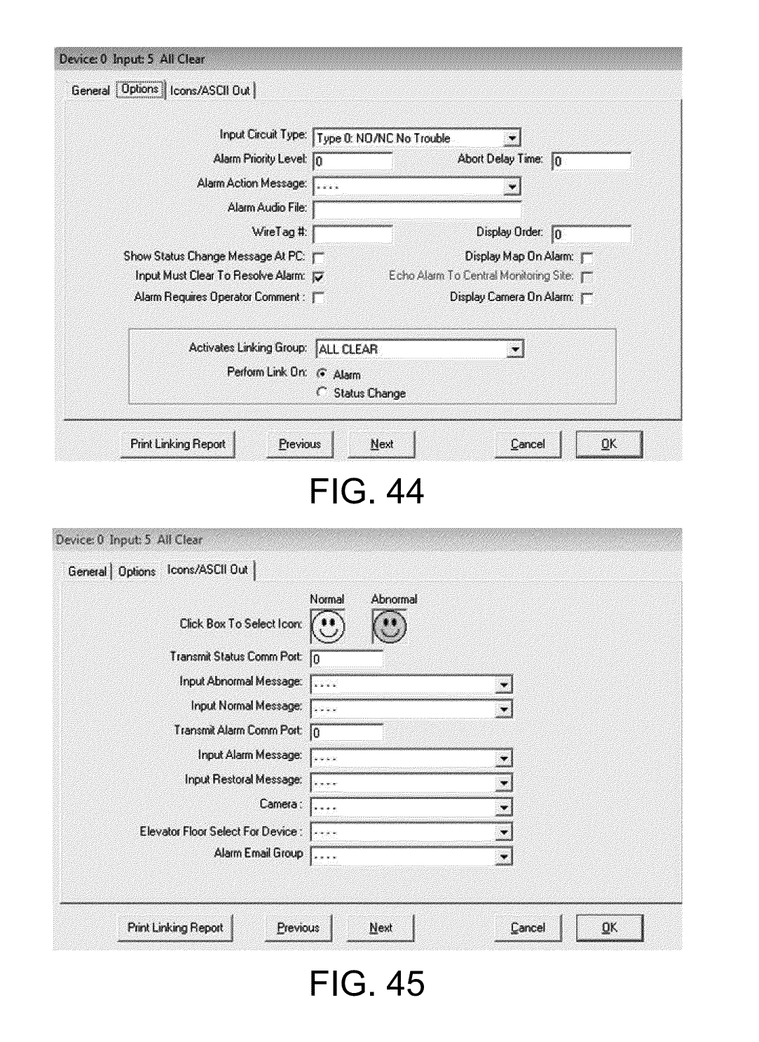

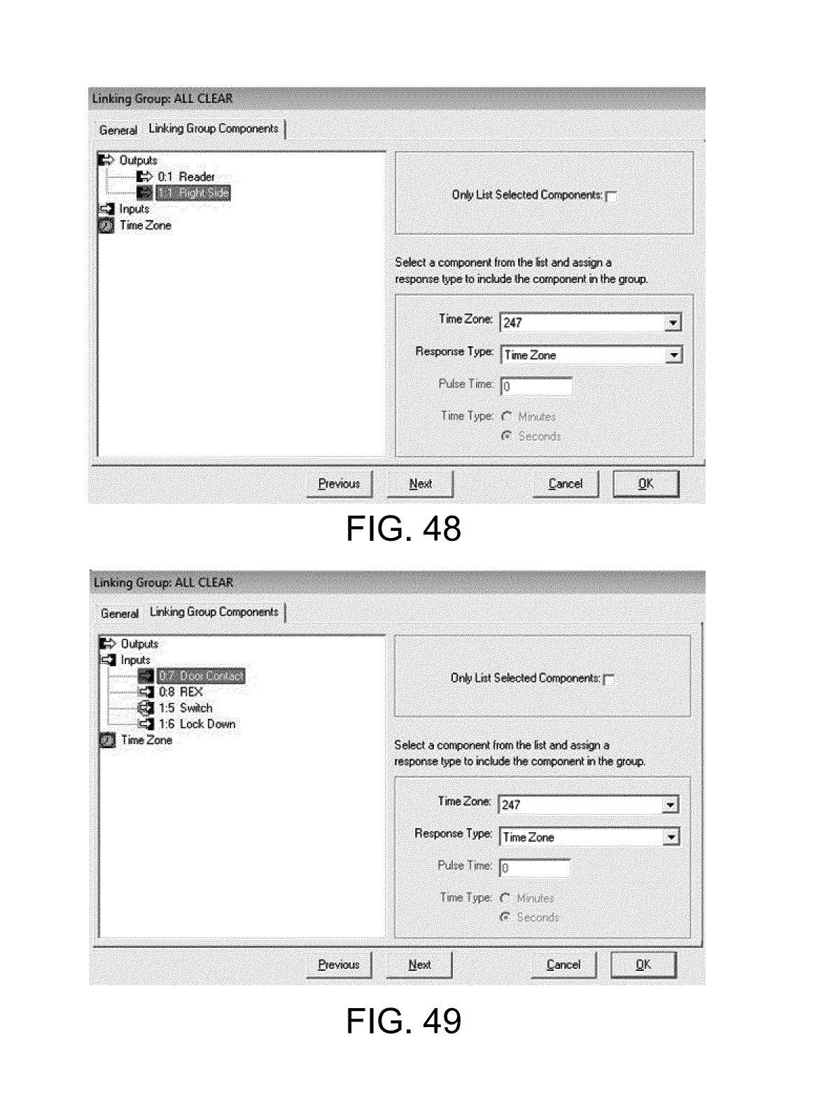

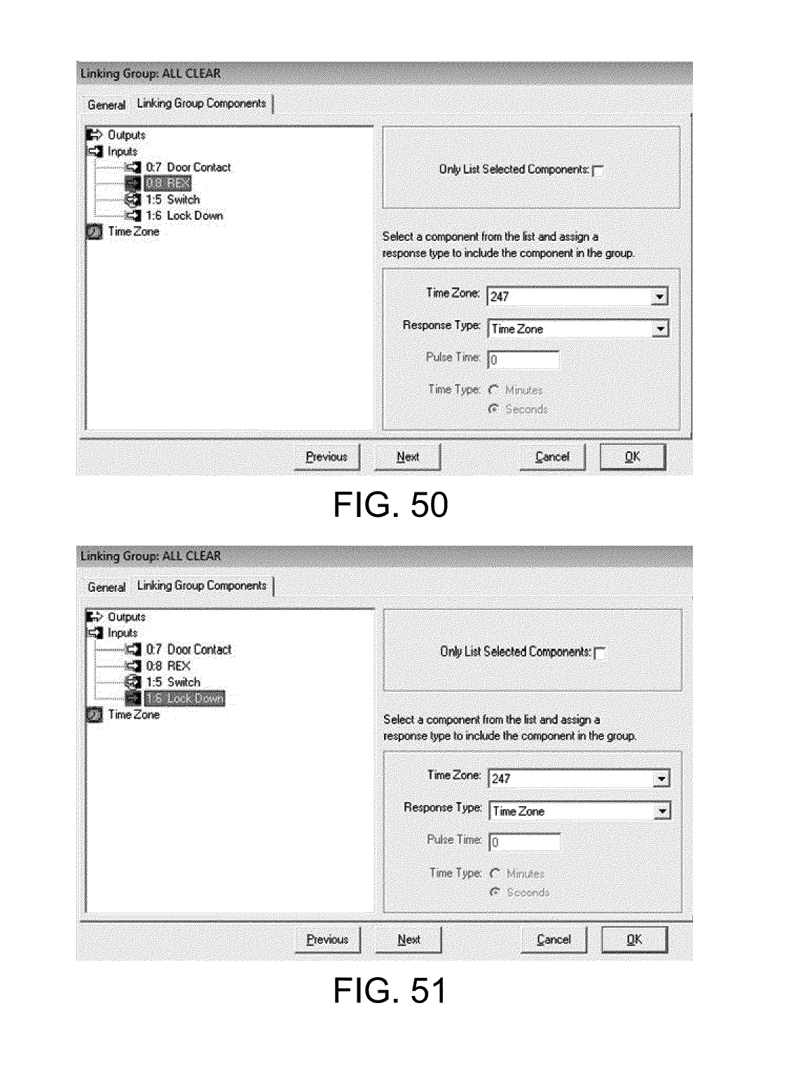

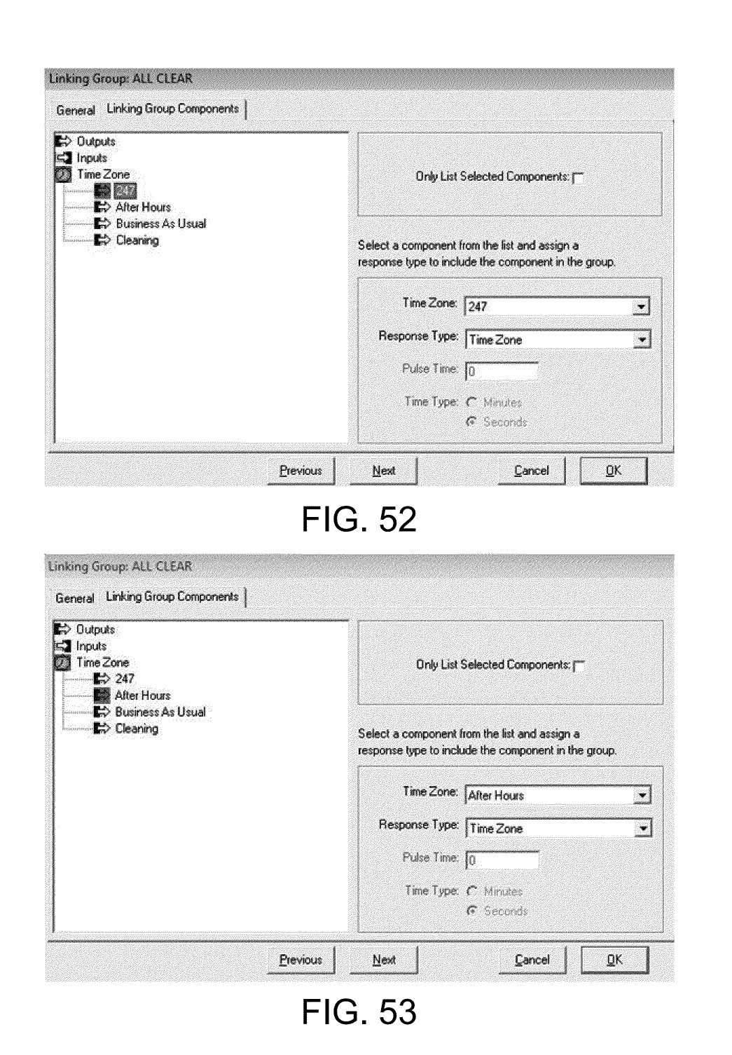

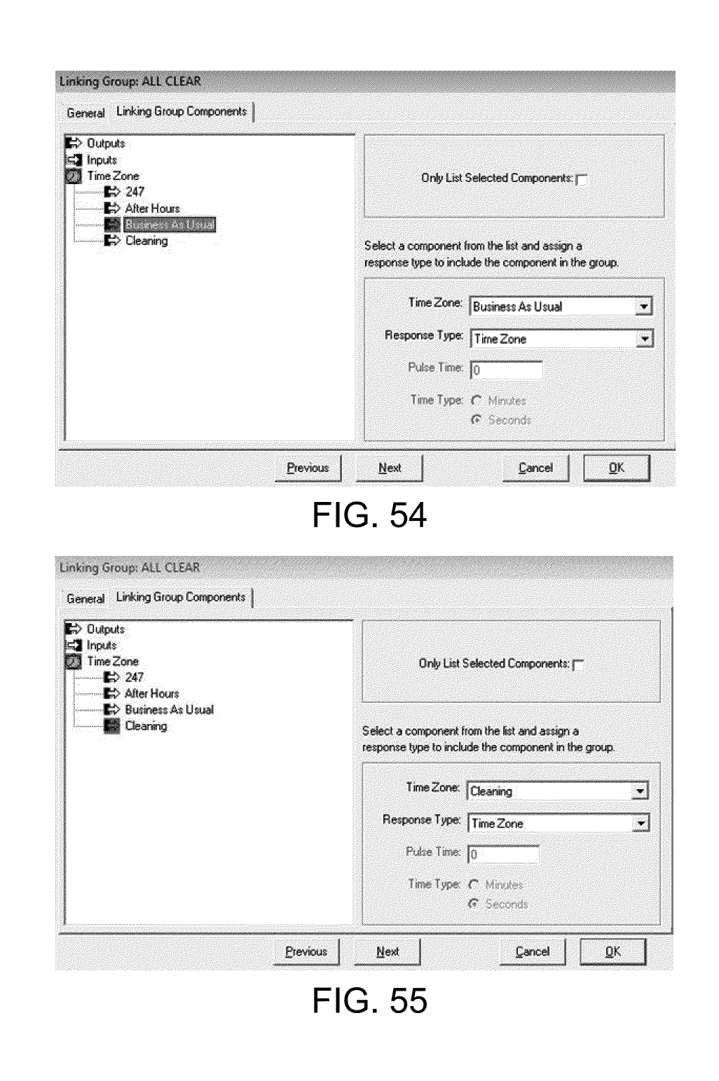

The details in FIGS. 18-33 show various features and programming for an Asterisk-based telephone system that define the hall monitor telephone system interface 250 and hall monitor telephone system functions 230 shown in FIG. 2. Examples of detailed programming for a DSX access control system to implement the hall monitor access control system interface 490 and hall monitor access control system functions 470 in FIG. 4 are shown in FIGS. 34-55. The specific example in FIGS. 34-55 show programming in a DSX access control system to support a Lockdown emergency event and an All Clear emergency event. When a Lockdown emergency event is initiated via the telephone system, the telephone system changes state of a defined contact on the interface between the telephone system and the access control system. This can be from a normally open state to a closed state, or from a normally closed state to an open state. The interface can be a relay on a XORCOM Astribank, or could be with a Viking Ring/Loop detector. The signal from the interface between the telephone system and the access control system is connected to an input on the access control system's input board. The Lockdown signal from the telephone system is typically asserted for one ring cycle, approximately five seconds, then returns to its normal state. FIGS. 34-37 show how the access control system is configured to detect the change in state from either normally open or normally closed. Note that FIG. 36 has checks in the boxes for Display Map on Alarm and Display Camera on Alarm. There is an existing defined interface between a Salient video surveillance system and a DSX access control system that allows the DSX access control system to control the Salient video surveillance system, as discussed in more detail below. The Display Camera on Alarm checkbox in FIG. 36 is a programmed feature that allows the DSX access control system to cause display of camera on a Lockdown event by the DXS access control system sending an appropriate command to the Salient video surveillance system, which results in the camera views being sent from the Salient video surveillance system to the DSX access control system. Note FIG. 37 shows ALL CAMS under the Camera option, which means the views from the cameras as defined in the “ALL CAMS” camera group in the video surveillance system will be sent to the DSX access control system during a Lockdown emergency event. A linking group is then configured using this input state change to activate several things simultaneously. FIGS. 38-42 show how the Time Zones settings are disabled during a Lockdown emergency event, all controlled doors are LATCHED (secured), and card readers are disabled.

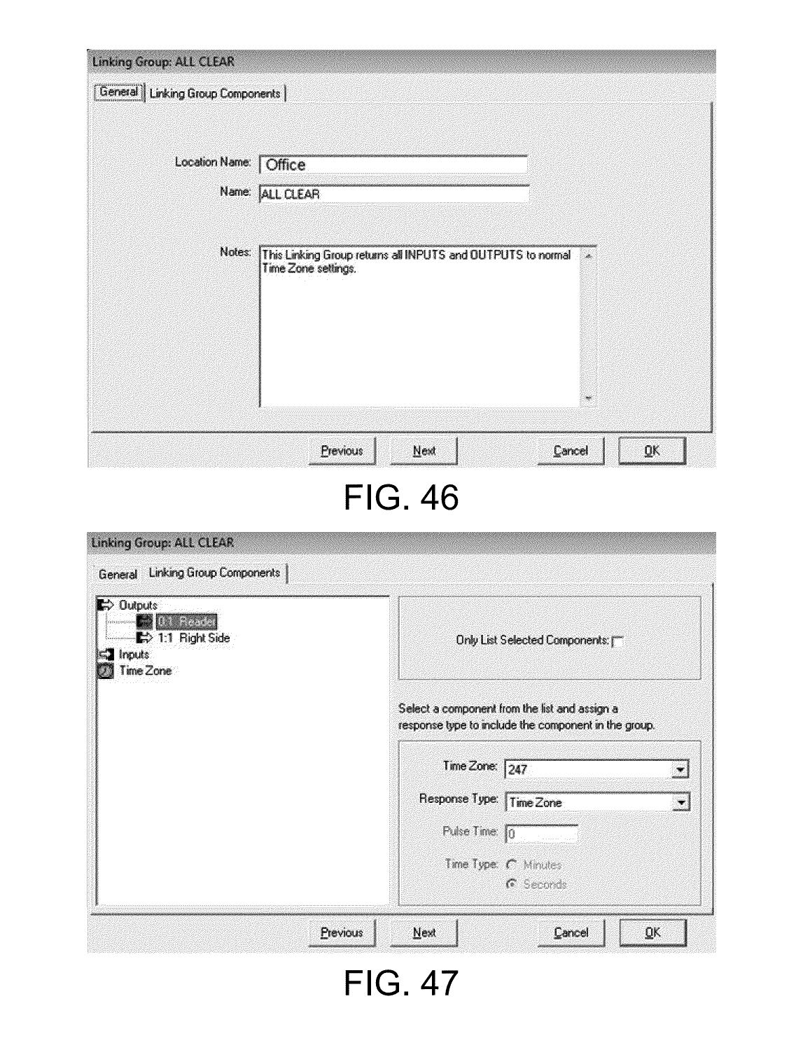

When an “All Clear” event is initiated via the telephone system to signal the end of the Lockdown event, a different signal on the interface between the telephone system and the access control system is triggered to change state for one ring cycle, approximately five seconds. FIGS. 43-45 show how the input is configured in the access control system software to detect the change in state on the programmable input corresponding to the All Clear signal from the telephone system. A linking group is then configured using this input state change to activate several things simultaneously. FIGS. 46-55 show how this linking group returns all input and output to normal Time Zone settings to indicate the Lockdown emergency event has ended, as indicated by the All Clear emergency event.

As mentioned above, there is a defined interface between a DSX access control system and a Salient video surveillance system with defined functions that allow the Salient video surveillance system to be controlled by the DSX access control system. The configuring and programming of the interface between the DSX access control system and the Salient video surveillance system is done using a common network infrastructure based on Internet Protocol (IP) addresses. Camera information from the Salient video surveillance system can thus be accessed with user credentials entered into the DSX access control system.

The examples shown in FIGS. 18-55 are shown for the purpose of illustrating how some of the programmable features for the hall monitor system can be implemented on specific platforms. Based on the detailed description and figures, one of ordinary skill in the art will know how to implement the programmable customized functions and programmable inputs/outputs for the video surveillance system and for the access control system to support the hall monitor system disclosed and claimed herein.

The details of the hall monitor system disclosed in FIGS. 1-55 thus disclose a method for handling emergency events, the method comprising: providing a telephone system that provides a plurality of telephony functions; providing a video surveillance system that provides at least one camera interface coupled to at least one camera and provides a plurality of video surveillance functions; providing an access control system that provides at least one door lock interface to a plurality of door locks and provides a plurality of access control functions; providing a plurality of interfaces between the telephone system, the video surveillance system, and the access control system, wherein at least one of the plurality of interfaces comprises relays; defining a plurality of emergency events that comprises: a lockdown event; a fire event; a weather event; a medical event; an evacuation event; and an all clear event; programming a first plurality of customized functions in the telephone system for the plurality of emergency events, wherein the first plurality of customized functions comprises: dialing an extension number to initiate one of the plurality of emergency events; sending at least one pre-written message corresponding to the one emergency event to at least one person; playing at least one pre-recorded message corresponding to the one emergency event over a public announcement system; playing at least one pre-recorded message corresponding to the one emergency event in a telephone call to at least one predefined telephone number; and providing a virtual telephone conference room; providing a dial-in menu for initiating at least one of the plurality of emergency events, for locking and unlocking doors, and for initiating the all clear event; providing a network interface that allows a remote user at a computer system to initiate at least one of the plurality of emergency events, to lock and unlock doors, and to initiate the all clear event; programming a second plurality of customized functions in the video surveillance system for the plurality of emergency events, wherein the second plurality of customized functions comprises displaying at least one image from at least one camera corresponding to an initiated emergency event; and programming a third plurality of customized functions in the access control system for the plurality of emergency events, wherein the third plurality of customized functions comprises at least one of: lock all doors; unlock all doors; lock selected doors; and unlock selected doors.

The hall monitor system provides a relatively low-cost, fully integrated solution for monitoring a facility for emergency events, for initiating emergency events, for providing all the needed actions and all the needed monitor and control functions during emergency events, and for terminating an emergency event (such as initiating the All Clear emergency event). The hall monitor system can use off-the-shelf hardware for the subsystems, then provide each subsystem with customized programming that defines programmable customized functions and programmable inputs/outputs that customize the off-the-shelf hardware to perform the functions of the hall monitor system. Of course, the hall monitor system could also be implemented using custom hardware and software, but this would increase the cost of the hall monitor system.

While the hall monitor system above is discussed with specific reference to schools, the hall monitor system could be used in any facility where a combination of telephone services, access control services, and video surveillance services are needed. Examples other than schools include hospitals, government buildings, private companies, factories and other manufacturing facilities, facilities that are spread across multiple buildings, etc. The disclosure and claims herein expressly extend to using the hall monitor system in any suitable location or environment.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
a telephone system that provides a plurality of telephony functions and provides a first plurality of customized functions supported by the telephone system for a plurality of emergency events;
a video surveillance system coupled to the telephone system that provides at least one camera interface coupled to at least one camera, that provides a plurality of video surveillance functions, and that provides a second plurality of customized functions supported by the video surveillance system for the plurality of emergency events; and
an access control system coupled to the telephone system and coupled to the video surveillance system that provides at least one door lock interface to a plurality of door locks, that provides a plurality of access control functions, and that provides a third plurality of customized functions supported by the access control system for the plurality of emergency events.

2. The apparatus of claim 1 wherein the plurality of emergency events comprises a lockdown event and an all clear event.

3. The apparatus of claim 2 wherein the plurality of emergency events further comprises a fire event, a weather event, a medical event and an evacuation event.

4. The apparatus of claim 1 wherein the first plurality of customized functions comprises dialing an extension number to initiate one of the plurality of emergency events and providing mass notification of the one emergency event.

5. The apparatus of claim 4 wherein providing the mass notification comprises sending at least one pre-written message corresponding to the one emergency event to at least one person and playing at least one pre-recorded message corresponding to the one emergency event over a public announcement system.

6. The apparatus of claim 1 wherein the first plurality of customized functions comprises providing a virtual telephone conference room.

7. The apparatus of claim 1 wherein the first plurality of customized functions comprises a dial-in menu for initiating at least one of the plurality of emergency events, for locking and unlocking doors, and for initiating an all clear event.

8. The apparatus of claim 1 wherein the first plurality of customized functions comprises a network interface that allows a remote user at a computer system to initiate at least one of the plurality of emergency events, to lock and unlock doors, and to initiate an all clear event.

9. The apparatus of claim 1 wherein the second plurality of customized functions comprises displaying at least one image from at least one camera corresponding to an initiated emergency event.

10. The apparatus of claim 1 wherein the third plurality of customized functions comprises at least one of:
lock all doors;
unlock all doors;
lock selected doors; and
unlock selected doors.

11. A method for handling emergency events, the method comprising:
providing a telephone system that provides a plurality of telephony functions;
providing a video surveillance system that provides at least one camera interface coupled to at least one camera and provides a plurality of video surveillance functions;
providing an access control system that provides at least one door lock interface to a plurality of door locks and provides a plurality of access control functions;
providing a plurality of interfaces between the telephone system, the video surveillance system, and the access control system;
defining a plurality of emergency events;
programming a first plurality of customized functions in the telephone system for the plurality of emergency events;
programming a second plurality of customized functions in the video surveillance system for the plurality of emergency events; and
programming a third plurality of customized functions in the access control system for the plurality of emergency events.

12. The method of claim 11 wherein the plurality of emergency events comprises a lockdown event and an all clear event.

13. The method of claim 12 wherein the plurality of emergency events further comprises a fire event, a weather event, a medical event and an evacuation event.

14. The method of claim 11 wherein the first plurality of customized functions comprises dialing an extension number to initiate one of the plurality of emergency events and providing mass notification of the one emergency event.

15. The method of claim 14 wherein providing the mass notification comprises sending at least one pre-written message corresponding to the one emergency event to at least one person and playing at least one pre-recorded message corresponding to the one emergency event over a public announcement system.

16. The method of claim 11 wherein the first plurality of customized functions comprises providing a virtual telephone conference room.

17. The method of claim 11 wherein the first plurality of customized functions comprises a dial-in menu for initiating at least one of the plurality of emergency events, for locking and unlocking doors, and for initiating an all clear event.

18. The method of claim 11 wherein the first plurality of customized functions comprises a network interface that allows a remote user at a computer system to initiate at least one of the plurality of emergency events, to lock and unlock doors, and to initiate an all clear event.

19. The method of claim 11 wherein the second plurality of customized functions comprises displaying at least one image from at least one camera corresponding to an initiated emergency event.

20. The method of claim 11 wherein the third plurality of customized functions comprises at least one of:
lock all doors;
unlock all doors;
lock selected doors; and
unlock selected doors.

21. A method for handling emergency events, the method comprising:
providing a telephone system that provides a plurality of telephony functions;
providing a video surveillance system that provides at least one camera interface coupled to at least one camera and provides a plurality of video surveillance functions;
providing an access control system that provides at least one door lock interface to a plurality of door locks and provides a plurality of access control functions;
providing a plurality of interfaces between the telephone system, the video surveillance system, and the access control system, wherein at least one of the plurality of interfaces comprises relays;
defining a plurality of emergency events that comprises:
a lockdown event;
a fire event;
a weather event;
a medical event;
an evacuation event; and
an all clear event;
programming a first plurality of customized functions in the telephone system for the plurality of emergency events, wherein the first plurality of customized functions comprises:
dialing an extension number to initiate one of the plurality of emergency events;
sending at least one pre-written message corresponding to the one emergency event to at least one person;
playing at least one pre-recorded message corresponding to the one emergency event over a public announcement system;
playing at least one pre-recorded message corresponding to the one emergency event in a telephone call to at least one predefined telephone number; and
providing a virtual telephone conference room;
providing a dial-in menu for initiating at least one of the plurality of emergency events, for locking and unlocking doors, and for initiating the all clear event;
providing a network interface that allows a remote user at a computer system to initiate at least one of the plurality of emergency events, to lock and unlock doors, and to initiate the all clear event;
programming a second plurality of customized functions in the video surveillance system for the plurality of emergency events, wherein the second plurality of customized functions comprises displaying at least one image from at least one camera corresponding to an initiated emergency event; and
programming a third plurality of customized functions in the access control system for the plurality of emergency events, wherein the third plurality of customized functions comprises at least one of:
lock all doors;
unlock all doors;
lock selected doors; and
unlock selected doors.
